(19) United States
(12) Patent Application Publication
(10) Pub. No.: US 2020/0249801 A1
(43) Pub. Date: Aug. 6, 2020

(54) ANALYSIS DEVICE, METHOD FOR CONTROLLING ANALYSIS DEVICE, CONTROL PROGRAM, AND RECORDING MEDIUM

(71) Applicant: SHARP KABUSHIKI KAISHA, Sakai City Osaka (JP)

(72) Inventors: NAOKI SHIOBARA, Sakai City (JP); MASAFUMI UENO, Sakai City (JP)

(73) Assignees: SHARP KABUSHIKI KAISHA, Sakai City, Osaka (JP); SHARP KABUSHIKI KAISHA, Sakai City, Osaka (JP)

(21) Appl. No.: 15/774,500

(22) PCT Filed: Sep. 20, 2016
(86) PCT No.: PCT/JP2016/077639

§ 371 Date: May 8, 2018

(30) Foreign Application Priority Data
Nov. 10, 2015 (JP) 2015-220753

(51) Int. Cl. G06F 3/0482; G06F 3/0488

(52) U.S. Cl. CPC G06F 3/0482; G06F 3/04883

(57) ABSTRACT

An association between each input area and processing can be made preferable for a user. A client device (1) includes an analysis unit (45) configured to analyze an execution log of near field radio communication performed by an operator using any of NFC antennas (121) to determine a preferred association between each of the NFC antennas (121) and the processing based on the prescribed rule.

### TECHNICAL FIELD

The following disclosure relates to an analysis device communicatively connected to an information processing device including an input unit.

### BACKGROUND ART

In an information processing device including an input unit with a plurality of input areas (e.g., antennas for Near Field radio Communication (hereinafter referred to as NFC), areas configured on a touch panel, and physical buttons), various types of processing can be performed by being associated with the respective input areas.

For example, PTL 1 discloses a technique in which antenna coils for NFC and a plurality of areas on the touch panel are associated with different types of processing (specifically, different types of processing for respective food orders and payment of fees).

### CITATION LIST

### Patent Literature

PTL 1: JP 2012-64123 A (published on: Mar. 29, 2012)

### SUMMARY OF INVENTION

### Technical Problem

However, in the information processing device described in PTL 1, an association between each of the input areas and the processing may not be preferable for an operator (user) operating the information processing device. Furthermore, PTL 1 discloses no technical concept that the association between each of the input areas and the processing is made preferable for a manager of the information processing device.

The following disclosure has been made in view of the above-described problems, and an object of the disclosure is to implement an analysis device configured to allow the association between each of the input areas and the processing to be made preferable for the operator or manager of the information processing device.

### Solution to Problem

To solve the above-described problems, an analysis device according to an aspect of the present invention is an analysis device configured to be communicatively connected to an information processing device including an input unit with a plurality of input areas, each of the input areas being associated with processing performed by the information processing device, the analysis device including: an analysis unit configured to analyze a log of input performed on any of the plurality of input areas by an operator output from the information processing device and to determine a preferred association between each of the plurality of input areas and the processing, based on a prescribed rule.

To solve the above-described problems, a method for controlling an analysis device according to an aspect of the present invention is a method for controlling an analysis layer communicatively connected to an information processing device including an input unit with a plurality of input areas, each of the input areas being associated with processing performed by the information processing device, the method including: an analysis step of analyzing a log of input performed on any of the plurality of the input areas by an operator output from the information processing device and determining a preferred association between each of the plurality of input areas and the processing based on a prescribed rule.

### Advantageous Effects of Invention

One aspect of the present invention is effective for allowing the association between each of the input areas and the processing to be made preferable for a user or manager of the information processing device.

### BRIEF DESCRIPTION OF DRAWINGS

FIG. 1 is a block diagram illustrating an example of a primary configuration of a client device according to a first embodiment.

FIG. 2 is a diagram illustrating a principle of near field radio communication.

FIG. 3 is a diagram illustrating an example of an external configuration of the client device.

FIG. 4 is a diagram illustrating an example of a change in a display layout according to the first embodiment.

FIG. 5 is a diagram illustrating another example of a change in the display layout according to the first embodiment.

FIG. 6 is a flowchart illustrating an example of a flow of analysis processing performed by the client device according to the first embodiment.

FIG. 7 is a diagram illustrating an example of a change in a display layout according to a second embodiment.

FIG. 8 is a flowchart illustrating an example of analysis processing performed by a client device according to the second embodiment.

FIG. 9 is a flowchart illustrating an example of analysis processing performed by a client device according to a third embodiment.

FIG. 10 is a block diagram illustrating an example of a primary configuration of a client device according to a fourth embodiment.

FIG. 11 is a diagram illustrating an example of a change in a display layout according to the fourth embodiment.

FIG. 12 is a diagram illustrating another example of a change in the display layout according to the fourth embodiment.

FIG. 13 is a block diagram illustrating an example of a primary configuration of a client device and a server included in an information processing system according to a fifth embodiment.

### DESCRIPTION OF EMBODIMENTS

### First Embodiment

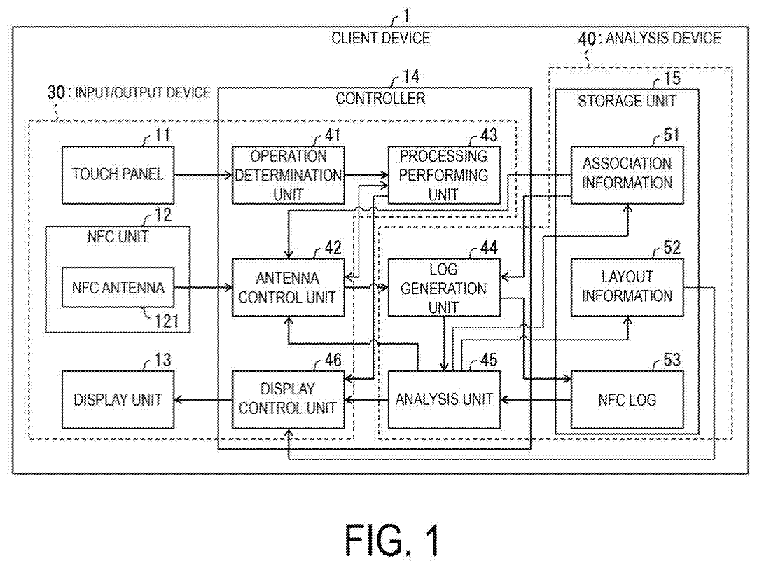

Hereinafter, a first embodiment of the present invention will be described with reference to FIG. 1 to FIG. 6.

### Client Device 1

First, a client device 1 (analysis device, information processing device) according to the present embodiment will be described. The client device 1 according to the present embodiment includes a plurality of antennas configured to perform near field radio communication (which may bereinafter be referred to as NFC), and each of the antennas is associated with processing performed by the client device 1. Furthermore, the client device 1 analyzes a log of NFC performed by a user to determine a preferred association between each of the antennas and the processing performed by the client device 1, based on a prescribed rule.

Here, the prescribed rule refers to a rule for determining the association between each of the antennas and the processing that allows an operator of the client device 1 to easily perform operations or a rule for determining the association between each of the antennas and the processing of the client device 1 that allows the operator to easily select processing desired by a manager of the client device 1.

Now, the primary configuration of the client device 1 will be described with reference to FIG. 1. FIG. 1 is a block diagram illustrating an example of the primary configuration of the client device 1. As illustrated in FIG. 1, the client device 1 is configured to include an input/output device 30 (information processing device) and an analysis device 40 integrated together, and includes a touch panel 11, an NFC unit 12 (input unit, near field radio communication unit), a display unit 13, a controller 14, and a storage unit 15.

The touch panel 11 includes a touch surface configured to receive contact with an object, and a touch sensor configured to detect contact between a pointer and the touch surface and to sense a position of input made by the contact. The touch sensor may be implemented by any sensor, provided the sensor is capable of detecting contact/non-contact between the pointer and the touch surface. For example, the touch sensor may be implemented with a pressure sensor, a capacitive sensor, a light sensor, or the like. In addition, the touch panel 11 may be configured to detect, as contact, a so-called “proximity state” in which an object is not in contact with the touch panel 11, but the distance between the touch panel 11 and the object is within a prescribed distance. The touch panel 11 outputs information (hereinafter referred to as positional information) indicative of the sensed input position (e.g., coordinates in a two-dimensional plane virtually configured on the touch panel 11) to an operation determination unit 41 described below.

The NFC unit 12 serves as a communication device configured to perform near field radio communication with external devices. The NFC unit 12 includes a plurality of NFC antennas 121 (input areas, antennas) each having a function to serve as a tag reader configured to sense an NFC tag and to transmit and/or receive information. For example, the NFC unit 12 is a sheet-like member provided between the touch panel 11 and the display unit 13, but the position of the NFC unit 12 is not limited to this example. Note that the number of NFC unit(s) 12 is not particularly limited so long as the NFC unit 12 includes a plurality of NFC antennas 121. Furthermore, the size and position of each of the NFC antennas 121 are not particularly limited. The NFC antennas 121 may be provided in the touch panel 11 (i.e., the touch panel 11 and the NFC unit 12 may be integrated together). The NFC antennas 121 output information received from an NFC tag to an antenna control unit 42 described below.

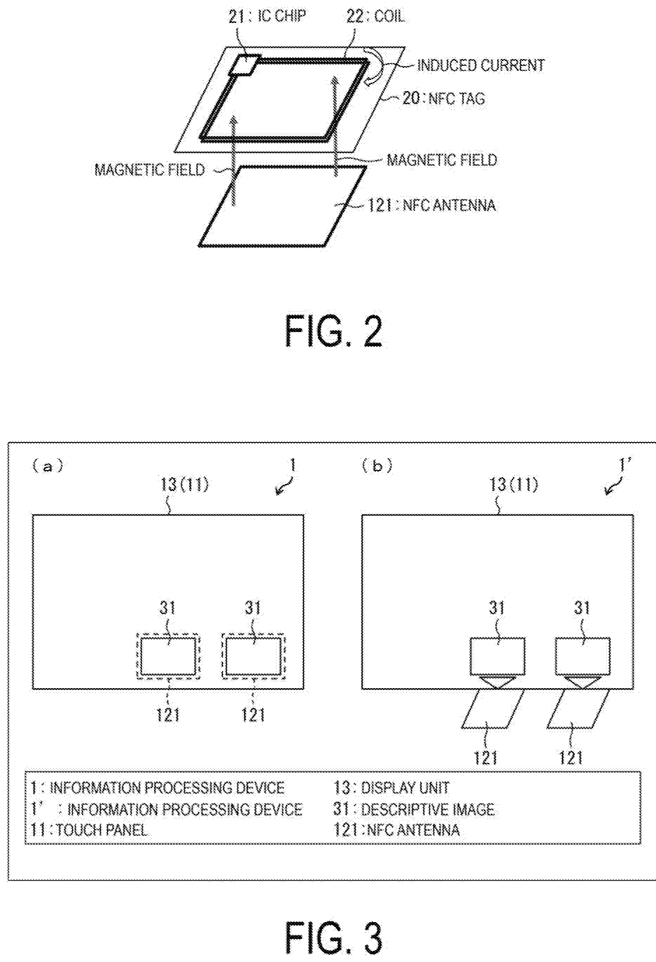

Now, the principle of NFC will be described with reference to FIG. 2. FIG. 2 is a diagram illustrating the principle of NFC. As illustrated in FIG. 2, an NFC tag 20 includes an IC chip 21 and a coil 22. The NFC antenna 121 periodically changes magnetic fields to perform polling to check for the presence of the NFC tag 20. Here, in a case where an operator (hereinafter referred to as a user) of the client device 1 holds the NFC tag 20 over one of the NFC antenna 121, the NFC antenna 121 changes the magnetic fields to cause electromagnetic induction in the NFC tag. A passive tag that is a type of the NFC tag 20 activates the IC chip 21 by an induced current resulting from the electromagnetic induction, and wirelessly transmits and/or receives information to and from the NFC antenna 121. Furthermore, an active tag that is a type of the NFC tag 20 includes a function to supply power to the IC chip 21, eliminating the need to activate the IC chip 21 using an induced current.

Regardless of whether the NFC tag 20 is a passive tag or an active tag, the NFC antenna 121 having transmitted information can generate a log indicative of the transmission of the information. The NFC is capable of performing bidirectional communication, and thus, the NFC antenna 121 can receive information from the NFC tag 20, As described above, the NFC tag 20 in the present embodiment may be either a passive tag or an active tag.

The display unit 13 serves as a display device configured to display, as an image in a display area, information to be processed by the client device 1. The display unit 13 is a liquid crystal display (LCD), for example, but is not limited to this example.

Now, an external configuration of the client device 1 will be described with reference to FIG. 3, FIG. 3 is a diagram illustrating the external configuration of the client device.

As illustrated in (a) of FIG. 3, the client device 1 according to the present embodiment is configured to include an NFC display with the touch panel 11, the NFC unit 12, and the display unit 13 stacked on one another. Specifically, the NFC display includes a protective glass, the touch panel 11, the NFC unit 12, and the display unit 13 that are stacked in that order from the outermost portion. The order of the members in the NFC display is not limited to this example.

The provision of the NFC display as described above enables the client device 1 according to the present embodiment to display descriptive images 31 indicative of processing (hereinafter referred to as “processing associated with the NFC antenna 121”) to be performed due to wireless communication between one of the NFC antennas 121 and the NFC tag 20 such that the descriptive images 31 overlap the respective NFC antennas 121, as illustrated in (a) of FIG. 3.

The external configuration of the client device according to the present embodiment is not limited to the example in (a) of FIG. 3. For example, as illustrated in (b) of FIG. 3, the client device according to the present embodiment may be a client device 1′ configured such that the NFC antennas 121 (i.e., the NFC unit 12) is not stacked on the touch panel 11 and the display unit 13. However, the client device needs a separate area where the NFC antennas 121 are provided, and an increased number of NFC antennas 121 hinder the user from easily understanding the positional relationship between the NFC antennas 121 and the descriptive images 31. Thus, as illustrated in (a) of FIG. 3, the client device according to the present embodiment is preferably configured to include the NFC display (configuration of the client device 1).

The controller 14 collectively controls functions of the client device 1. As illustrated in FIG. 1, the controller 14 includes the operation determination unit 41, an antenna control unit 42, a processing performing unit 43, a log generation unit 44, an analysis unit 45 (output unit), and a display control unit 46

### Operation Determination Unit 41

The operation determination unit 41 determines which of the plurality of input areas configured on the touch panel 11 corresponds to the input area on which the user has performed an input operation (touch operation), based on the positional information acquired from the touch panel 11. The operation determination unit 41 then determines processing to be performed by the processing performing unit 43, based on the determined area, and instructs the processing performing unit 43 to perform the determined process. For example, the operation determination unit 41 instructs the processing performing unit 43 to make a change in a displayed image in the display unit 13 as the processing to be performed by the processing performing unit 43.

### Antenna Control Unit 42

The antenna control unit 42 determines the processing to be performed by the processing performing unit 43, based on the information indicating which of the NFC antennas 121 has performed NFC with the NFC tag 20 (antenna identification information described below), and instructs the processing performing unit 43 to perform the determined processing. Furthermore, in a case where the determined processing needs information acquired from the NFC tag 20, the antenna control unit 42 outputs the information to the processing performing unit 43. The antenna control unit 42 instructs the processing performing unit 43 to perform, for example, billing processing as the processing to be performed by the processing performing unit 43, and outputs a portion of the acquired information that is needed for the billing processing (e.g., the user's personal information received from the NFC tag 20) to the processing performing unit 43.

Furthermore, in a case of acquiring the information from one of the NFC antennas 121, the antenna control unit 42 outputs, to the log generation unit 44, a notification indicating that communication with the NFC tag 20 has been performed and antenna identification information identifying the NFC antenna 121 having communicated with the NFC tag 20.

In accordance with an instruction from the analysis unit 45, the antenna control unit 42 reads association information 51 stored in the storage unit 15 (association information 51 updated in accordance with an analysis performed by the analysis unit 45) and changes the association between each of the NFC antennas 121 and the processing performed by the client device 1. A detailed description of this operation will be given below. Note that the association. information 51 is information indicative of the association between each of the NFC antennas 121 and the processing performed by the client device 1, specifically, information associating the antenna identification information on each of the NFC antennas 121 with the contents of processing performed in a case where NFC is performed via the NFC antenna 121 indicated by the antenna identification information.

### Processing Performing Unit 43

The processing performing unit 43 performs processing indicated by the operation determination unit 41 or the antenna control unit 42. Specifically, the processing performing unit 43 performs processing corresponding to the user's touch operation or NFC. Specific examples of the processing include the processing for changing a display screen and the billing processing as described above. However, the present embodiment is not limited to these examples.

In a case where the client device 1 is configured to be able to communicate with external devices and needs to communicate with any of the external devices for performing processing, the processing performing unit 43 communicates with the external device via a communication unit (not illustrated).

### Log Generation Unit 44

The log generation unit 44 generates a log (log of inputs) indicative of the input areas each selected by the user as a target for the input operation and the processing associated with the respective input areas in a prescribed period. Specifically, the log generation unit 44 acquires, from the antenna control unit 42, the antenna identification information indicative of the NFC antenna 121 via which NFC has been performed, reads the association information 51 from the storage unit 15, associates the antenna identification information with the association information 51, and stores the resultant information in an NFC log 53 (log of inputs) (updates the NFC log 53). The NFC log 53 indicates, in chronological order, correspondence relations between each of the NFC antennas having performed NFC and the processing associated with the NFC antenna 121 at the time of the performing of the NFC, in other words, a log of performing of NFC.

The log generation unit 44 notifies the analysis unit 45 that the NFC log 53 has been updated. Note that the NFC log 53 is generated as a new file in a case where the association between each of the NFC antennas 121 and the processing of the client device 1 is changed. Thus, the NFC log 53 is generated for each piece of association information 51.

### Display Control Unit 46

The display control unit 46 changes a display layout of the descriptive images 31 in accordance with an instruction from the analysis unit 45. Specifically, in a case of acquiring a layout change instruction from the analysis unit 45, the display control unit 46 reads layout information 52 from the storage unit 15 and changes the layout of the descriptive images 31, based on the layout information 52, as described below.

### Storage Unit 15

The storage unit 15 stores various types of data used by the client device 1. The storage unit 15 stores at least the association information 51, the layout information 52, and the NFC log 53. The association information 51, the layout information 52, and the NFC log 53 will be described below.

### Analysis Unit 45

The analysis unit 45 analyzes the NFC log 53 to determine a preferred association between each of the NFC antennas 121 and the processing performed by the client device 1 as a result of performing of NFC, based on the prescribed rule. Specifically, in a case of receiving, from the log generation unit 44, a notification indicating that the NFC log 53 has been updated, the analysis unit 45 refers to the NFC log 53 to determine the total count of NFC for the current association (hereinafter referred to as the total communication count). The analysis unit 45 then determines Whether the determined total communication count of NFC sessions corresponds to a sufficient sample size for statistical data. Specifically, preferably, a threshold is preset based on the number of users of the client device 1 during a prescribed period, and whether the determined total communication count is equal to or larger than the threshold is determined. However, in a case where configuration of the threshold is difficult, for example, immediately after installation of the client device 1, a method of calculating the threshold (i.e., the sufficient sample size for statistical data) from the following relationship may be employed. Note that the method for calculating the threshold from the following relationship is merely an example and the present embodiment is not limited to this method.

n≥N/[(E/Z)²×(N−1)×(N−1)/{P×(1−P)}+1]

where n denotes the sample size, and N denotes the size of a population (hereinafter referred to as a population parameter). Furthermore, E denotes a maximum error (i.e., the size of an allowable error). E is any value appropriately configured by an investigator and is typically set as E=0.05. Z denotes the value of a normal distribution at a confidence coefficient. Here, the confidence coefficient is “1−α”, which is sufficiently close to 1 (0<α<1), in a case where, when a population parameter is estimated, the probability that the population parameter is included in a certain interval (confidence interval) is defined as “1−α”. In other words, Z is a coefficient for the normal distribution obtained from the confidence coefficient appropriately configured by the investigator, and the confidence coefficient is typically 0.95. In a case where the confidence coefficient is 0.95, Z=1.96. P denotes a predicted ratio of the population. P is also any value appropriately configured by the investigator, However, in a case where the prediction is difficult, P may be set as P=0.5. Thus, the above-described threshold may be configured as a value obtained by calculating the right side of the above-described relationship.

For example, for N=100, in a case where the size of the samples is obtained with E=0.05, Z=1,96, and P=0.5, then n>80. In other words, for the size of the population being 100, the total communication count is determined to correspond to the sufficient sample size for statistical data in a case where the determined total communication count is 80 or more (i.e., in a case where NFC is performed 80 times in connection with the association indicated by the acquired association information 51).

In a case of determining that the total communication count corresponds to the sufficient sample size for statistical data, the analysis unit 45 analyzes the NFC log 53. In an example of the analysis, the analysis unit 45 references the antenna identification information stored in the NFC log 53 to determine the count of NFC sessions via each of the NFC antennas 121 (hereinafter referred to as the communication count). The analysis unit 45 then divides the determined communication count for each NFC antenna 121 by the total communication count to determine the ratio of the communication count for each NFC antenna to the total communication count of NFC sessions.

The analysis unit 45 then determines the association between each of the NFC antennas 121 and the processing performed by the client device 1, based on the prescribed rule. Specifically, the analysis unit 45 determines whether analysis results satisfy a prescribed condition. In the above-described example, it is determined whether any of the NFC antenna 121 with the determined ratio being larger than a prescribed threshold exists. In a case of determining that such a NFC antenna 121 exists, the analysis unit 45 refers to the association information 51 to determine whether the association between each of the NFC antennas 121 and the processing performed by the client device 1 needs to be changed.

In a case of determining that the association needs to be changed, the analysis unit 45 updates the association information 51 such that the processing associated with the NFC antenna 121 indicated by the antenna identification information is associated with the NFC antenna 121 located at a position most conveniently utilized by the user (e.g., the center of the NFC display).

The analysis unit 45 then outputs an association change instruction for a change in the association between each of the NFC antennas 121 and the processing to the antenna control unit 42 to allow the antenna control unit 42 to change the association between each of the NFC antennas 121 and the processing performed by the client device 1.

The analysis unit 45 updates the layout information 52 (stored in the storage unit 15) indicative of the display layout (arrangement of images) of the descriptive images 31, based on the change in the association, and outputs, to the display control unit 46, a layout change instruction (arrangement change instruction) for a change in the display layout based on the updated layout information 52.

On the other hand, in a case of determining that no NFC antenna 121 with the determined ratio being larger than the prescribed threshold exists, and in a case of determining that the association need not be changed, the analysis unit 45 terminates the processing. The configuration of determining whether the ratio of the count of NFC sessions performed via each NFC antenna 121 exceeds the threshold is merely an example, and the analysis performed by the analysis unit 45 is not limited to the above-described example.

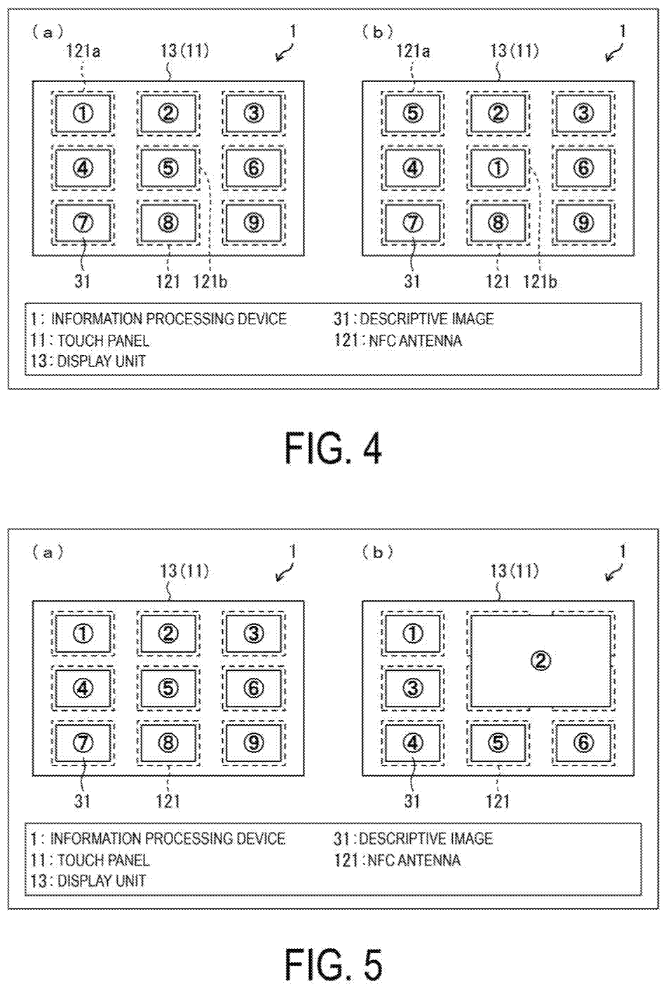

Here, the analysis and the output of the instruction performed by the analysis unit 45 as described above will be described in further detail with reference to FIG. 4. FIG. 4 is a diagram illustrating an example of a change in the display layout according to the first embodiment. (a) of FIG. 4 illustrates the display layout of the descriptive images 31 and the association between each of the NFC antennas 121 and the processing, before the analysis. The nine antennas 121 are associated with different types of processing labeled “1” to “9” as illustrated in (a) of FIG. 4, and the descriptive images 31 indicating the different types of processing “1” to “9” are displayed at positions on the display unit 13 that overlap the respective NFC antennas 121. For example, the uppermost left antenna 121a is associated with the processing labeled “1”, and at a position on the display unit 13 that overlaps this NFC antenna 121, displayed is the descriptive image 31 indicating that holding the NFC tag 20 at this position causes the processing labeled “1” to be performed by the client device 1 (hereinafter referred to as the “descriptive image 31 indicative of the processing for . . . ”. Note that a portion of “. . . ” is filled with alphanumerical characters, words, or the like).

Furthermore, among the NFC antennas 121 illustrated in (a) of FIG. 4, the antenna located at the position most conveniently utilized by the user is assumed to be the NFC antenna 121b associated with the processing “5”.

As described above, the analysis unit 45 references the NFC log 53 to determine, for each NFC antenna 121, the ratio of the count of communication sessions performed via the particular NFC antenna 121 to the total communication count (hereinafter referred to as the ratio of the communication count). In this case, the ratio for the NFC antenna 121a associated with the processing “1” is assumed to exceed the prescribed threshold. This indicates that, of the different types of processing “1” to “9”, the processing “1” is frequently utilized by the user.

Then, the analysis unit 45 refers to the association information 51 to determine whether the association and the display layout need to be changed. Specifically, the analysis unit 45 determines whether the processing “1” is associated with the NFC antenna 121b. In this example, the analysis unit 45 determines that the association and the display layout need to be changed.

The analysis unit 45 updates the association information 51 such that the processing “1” is associated with the central NFC antenna 121b (i.e., the NFC antenna 121 most conveniently utilized by the user). Furthermore, based on the change in the association, the analysis unit 45 changes the layout information 52 indicative of the display layout of the descriptive images 31. in the example in FIG. 4, the layout information 52 is information indicative of the display layout of the descriptive images 31 illustrated in (b) of FIG. 4. The analysis unit 45 outputs the association change instruction to the antenna control unit 42. The analysis unit 45 outputs the layout change instruction to the display control unit 46

In a case of receiving the association change instruction from the analysis unit 45, the antenna control unit 42 reads the association information 51 from the storage unit 15, and changes the association between each of the NFC antennas 121 and the processing performed by the client device 1, based on the association information 51. In a case of receiving the layout change instruction from the analysis unit 45, the display control unit 46 reads the layout information 52 from the storage unit 15 and changes the display layout of the descriptive images 31, based on the layout information 52.

In the example in FIG. 4, as a result of the changes in the association and the display layout, the association between each of the NFC antennas 121 and the processing performed by the client device 1 and the display layout of the descriptive images 31 are changed to those illustrated in (b) FIG. 4. Specifically, the processing “1” is associated with the central NFC antenna 121b, and the processing “5” is associated with the uppermost left NFC antenna 121a. The display position of the descriptive image 31 indicating the processing “1” corresponds to the position overlapping the NFC antenna 121b, and the display position of the descriptive image 31 indicating the processing “5” corresponds to the position overlapping the NFC antenna 121a.

This allows the position most frequently utilized by the user to be associated with the NFC antenna 121 located at the position most conveniently utilized by the user, and also allows the user to recognize the association.

As described above, the analysis unit 45 determines the association between each of the NFC antennas 121 and the processing performed by the client device 1, based on the relative frequency of the NFC performed on each NFC antenna 121. The changes in the association and the display layout illustrated in FIG. 4 are merely examples and are not limited to this example. For example, processing that can be performed by the first 100 users may be associated with the NFC antenna 121b, and at a point in time when the communication count for the NFC antenna 121h reaches 100, a change may be made to associate the NFC antenna 121b with another type of processing. According to the change in the association, the display layout may be changed.

### Change Example

The analysis unit 45 may perform an analysis based not only on the communication count during a period for the association indicated by the acquired association information 51, i.e., the association between each of the NFC antennas 121 and the processing performed by the client device 1 at the point in time when NFC is performed (hereinafter referred to as the current association) but also on the communication count aggregated for a past prescribed period for an association different from the current association (hereinafter referred to as a past association), and determine which of the two associations is preferable.

Determination of which of the two associations is preferable allows determination of whether the current association and display layout have produced results expected by a manager of the client device 1. In a case where the expected results have failed to be achieved, the association and the display layout can be returned to the past ones.

Details of the analysis will be specifically described below with reference to FIG. 5. FIG. 5 is a diagram illustrating another example of a change in the display layout according to the first embodiment. (a) of FIG. 5 illustrates the past display layout of the descriptive images 31 and the past association between each of the NFC antennas 121 and the processing, before the analysis, and (b) of FIG. 5 illustrates the current display layout of the descriptive images 31 and the current association between each of the NFC antennas 121 and the processing.

In the example in FIG. 5, the manager desires to allow the user of the client device 1 to perform the processing labeled “2”, and changes the association and the display layout in such a manner as to associate the processing labeled “2” with the four NFC antennas 121 as illustrated in (b) of FIG. 5. Furthermore, as a result of the change, the different types of processing “7” to “9” provided in the association and display layout illustrated in (a) of FIG. 5 are omitted from the association and display layout illustrated in (b) of FIG. 5. In the example in FIG. 5, whether an execution count for the processing labeled “2” has increased as expected by the manager can be determined by performing an analysis based on the communication count during the period for the current association and on the communication count during the period for the past association.

First, the analysis unit 45 refers to the NFC log 53 to determine the total communication count in each of the states with the current and past associations. Here, either of the communication counts is assumed to have been determined to correspond to the sufficient sample size for statistical data.

The analysis unit 45 subsequently references the NFC log 53 to determine the communication count for each NFC antenna 121 for the current association (hereinafter referred to as the current communication count) and the communication count for each NFC antenna 121 for the past association (hereinafter referred to as the past communication count). The analysis unit 45 then determines the ratio of the count of NFC sessions via each NFC antenna 121 to the total communication count of NFC sessions for the current and past associations (the determined ratios are hereinafter referred to as the current ratio and the past ratio, respectively), based on the current communication count and the past communication count.

The analysis unit 45 subsequently compares the current ratio with the past ratio to determine whether a prescribed condition is satisfied. Here, the prescribed condition is a condition pre-configured by the manager and is, in the example in FICA. 5, whether the ratio of the count of NFC sessions via the NFC antenna 121 associated with the processing labeled “2” according to the current association is higher than the ratio of the count of NFC sessions via the NFC antenna 121 associated with the processing labeled “2” according to the past association (i.e., whether the execution count for the processing labeled “2” has increased as expected by the manager).

In a case where the ratio has increased, the analysis unit 45 terminates the processing without outputting the association change instruction or the layout change instruction.

On the other hand, in a case where the ratio has not increased, the association of a plurality of the NFC antennas 121 with the different types of processing labeled “7” to “9” is more convenient for the user than the association of these NFC antennas 121 with the processing labeled “2” (the user can perform the different types of processing labeled “7” to “9” without operating the touch panel 11 to change the association and the display layout). Thus, the analysis unit 45 changes the association information 51 to association information indicative of the past association and also changes the layout information 52. The analysis unit 45 allows the antenna control unit 42 to change the association between each of the NFC antennas 121 and the processing performed by the client device 1 to the association illustrated in (a) of FIG. 5. The analysis unit 45 also allows the display control unit 46 to change the display layout of the descriptive images 31 to the display layout illustrated in (a) of FIG. 5.

Note that the analysis unit 45 may compare the current ratio with the past ratio for the NFC antenna 121 other than the NFC antenna 121 associated with the processing labeled “2”. This allows examination of the tendency of changes in the count of NFC sessions via each NFC antenna 121 resulting from changes in the association.

In the above-described example, the configuration which compares the current ratio with the past ratio is described, but ratios based on past associations different from each other may be compared with each other. Alternatively, three or more associations may be used for the comparison.

As described above, the analysis unit 45 compares the relative frequency of the input operation on each input area during a first period in which a first association between each of the NFC antennas 121 and the processing performed by the client device 1 is used, with the relative frequency of the input operation on each NFC antenna 121 during a second period in which a second association between each of the NFC antennas 121 and the processing performed by the client device 1 is used, thereby determining which of the first association and the second association is preferable.

Note that, in a case where a comparison is performed on a plurality of periods for different associations, whether comparison results indicate a significant difference between the comparison targets may be determined and that the present embodiment is not limited to the above-described example where whether a plurality of determined ratios satisfy the prescribed condition is determined. Whether the results indicate a significant difference cart be statistically determined by selectively using various provisional tests suitable for the comparison targets. The provisional tests used may be preset in the client device 1 according to the comparison targets.

Changes in Association and Display Layout Based on Instruction from the Manager

The antenna control unit 42 and the display control unit 46 may change the association between each of the NFC antennas 121 and the processing performed by the client device 1 and the display layout of the descriptive images 31, based on an instruction from the manager.

An example of such changes may be a case where the manager's instruction to change the display screen results in changes in the association and the display layout. In this case, the analysis unit 45 updates the association information 51 stored in the storage unit 15, based on the instruction input by the manager. Furthermore, based on the change in the association, the analysis unit 45 changes the layout information 52 indicative of the display layout of the descriptive images 31.

### Flow of Analysis Processing

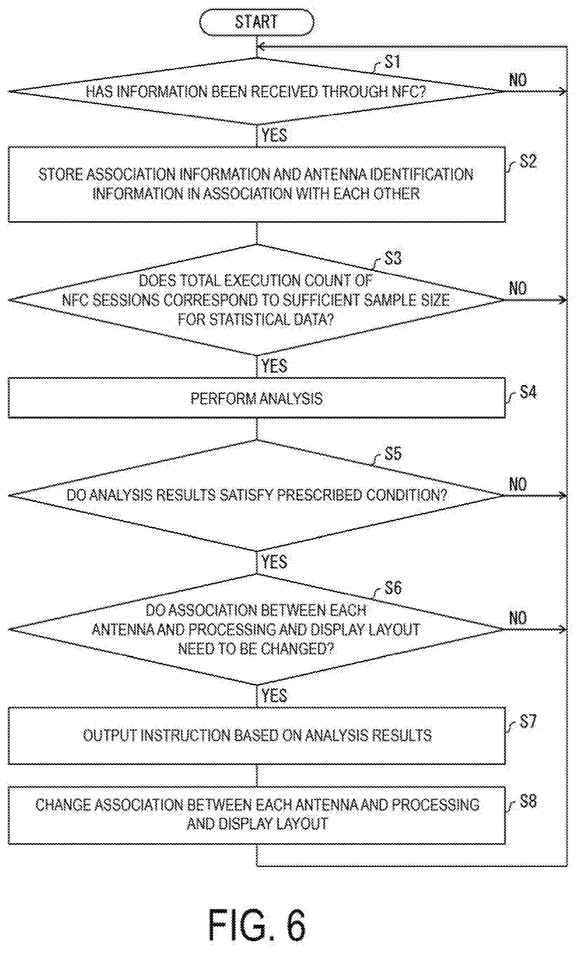

Next, a flow of the analysis processing performed by the client device 1 will be described with reference to FIG. 6. FIG. 6 is a flowchart illustrating an example of the flow of the analysis processing performed by the client device 1. FIG. 6 illustrates processing performed after, with the client device 1 activated, the user performs the touch operation on the touch panel 11 to allow the display unit 13 to display a screen on which NFC can be performed (e.g., a screen illustrated in (a) of FIG. 4). This also applies to other flowcharts illustrated below.

The antenna control unit 42 is in a state of waiting to receive information through NFC (step S1, “step” is omitted from the following description). In a case where the information is received through NFC (YES in S1), the antenna control unit 42 outputs, to the log generation unit 44, a notification indicating that communication with the NFC tag 20 has been performed and antenna identification information identifying the NFC antenna 121 having communicated with the NFC tag 20.

Subsequently, in a case of receiving the notification indicating that communication with the NFC tag 20 has been performed from the antenna control unit 42, the tog generation unit 44 stores the antenna identification information and the association information 51 in association with each other (S2). Specifically, the log generation unit 44 reads the association information 51 from the storage unit 15, associates the association information 51 with the antenna identification information acquired from the antenna control unit 42, and stores the associated two types of information in the NFC log 53 stored in the storage unit 15 (the log generation unit 44 updates the NFC log 53). After updating the NFC log 53, the log generation unit 44 outputs the notification indicative of the update to the analysis unit 45,

Subsequently, in a case of receiving, from the tog generation unit 44, the notification indicating that the NFC log 53 has been updated, the analysis unit 45 refers to the NFC log 53 to determine the total execution count of NFC sessions for the current association (the total communication count), thus determining whether the determined total communication count corresponds to the sufficient sample size for statistical data (S3). In a case of determining that the total communication count does not correspond to the sufficient sample size for statistical data (NO in S3), the analysis unit 45 temporarily terminates the analysis processing, and the client device 1 waits to receive information through the next NFC (i.e., the client device 1 returns to S1).

On the other hand, in a case of determining that the total communication count corresponds to the sufficient sample size for statistical data (YES in S3), the analysis unit 45 analyzes the information stored in the NFC log 53 (S4, analysis step). For example, the analysis unit 45 performs the analysis described with reference to FIG. 4 and FIG. 5. The analysis unit 45 then determines whether analysis results satisfy a prescribed condition (S5). In a case where the analysis results do not satisfy the prescribed condition (NO in S5), the analysis unit 45 temporarily terminates the analysis processing, and the client device 1 waits to receive information through the next NFC (i.e., the client device 1 returns to S1).

On the other hand, in a case where the analysis results satisfy the prescribed condition (YES in S5), e.g., in a case where the ratio, to the determined total communication count, of the count of NFC sessions (communication count) performed via the NFC antenna 121 associated with the processing “1” illustrated in (a) of FIG. 4 exceeds the prescribed threshold, the analysis unit 45 determines whether the association between each of the antennas and the processing needs to be changed (S6). Specifically, the analysis unit 45 determines whether the processing “1” selected as a frequently performed processing by the operator is associated with the central NFC antenna 121b, which is easily operated. In a case of determining that the association need not be changed (the processing “1” is associated with the NFC antenna 121b) (NO in S6), the analysis unit 45 temporarily terminates the analysis processing, and the client device 1 waits to receive information through the next NFC (i.e., the client device 1 returns to S1).

On the other hand, in a case of determining that the association needs to be changed (YES in S6), the analysis unit 45 updates the association information 51 based on the change in the association and also updates the layout information 52 based on the change in the association. The analysis unit 45 outputs the association change instruction for the change in the association between each of the NFC antennas 121 and the processing to the antenna control unit 42, and also outputs the layout change instruction for the change in the display layout of the descriptive images 31 to the display control unit 46 (S7). The antenna control unit 42 which receives the association change instruction reads the association information from the storage unit 15, and changes the association between each of the NFC antennas 121 and the processing performed by the client device 1. The display control unit 46 which receives the layout change instruction reads the layout information 52 from the storage unit 15 and changes the display layout of the descriptive images 31 (S8). Then, the client device 1 waits to receive information through the next NFC the client device 1 returns to S1).

As described above, in a case where NFC with the NFC tag has been performed, the client device 1 stores the antenna identification information indicative of the NFC antenna 121 via which the NFC has been performed and the association information 51 indicative of the current association between each of the NFC antennas 121 and the processing performed by the client device 1, in the NFC log 53 in association with each other. The client device 1 performs the analysis using these types of information stored in the NFC log 53. In a case where the preferred association determined by the analysis unit 45 is different from the association of the current point in time, the client device 1 changes the association to the above-described preferred association and also changes the display layout of the descriptive images 31 in accordance with the change in the association. Consequently, the association and the display layout can be changed with the NFC performed by the client device 1 taken into account. As a result, the association and the display layout can be made preferable for the user and manager of the client device 1.

Accuracies needed for calculation of the sample size and the presence or absence of a significant difference depend greatly on utilization conditions and the like and may thus be appropriately configured by the manager of the client device 1 according to the utilization conditions.

Furthermore, in a case where the client device 1 needs no touch operation, the NFC display of the client device 1 may be configured such that only the NFC unit 12 and the display unit 13 are stacked, i.e., the NFC display may be configured not to include the touch panel 11. In this case, the controller 14 is configured not to include the operation determination unit 41.

Furthermore, the client device 1 is not limited to the configuration for performing the analysis using the ratio of the execution count of NFC sessions via each NFC antenna 121 to the total execution count of NFC sessions. For example, the client device 1 may determine whether to change the above-described association by comparing the execution counts of NFC sessions via the respective NFC antennas 121 with one another. Specifically, in a case where the execution count of NFC sessions via a first NFC antenna 121 is a prescribed number more than the execution count of NFC sessions via a second NFC antenna 121 and that the execution count of NFC sessions via the first NFC antenna 121 exceeds a prescribed threshold, the client device 1 may interchange the processing associated with the first NFC antenna 121 with the processing associated with the second NFC antenna 121,

In an analysis involving only the comparison of the execution count of NFC sessions with the prescribed threshold, there is a problem in which the analysis fails to take the total execution count of NFC sessions into account. Specifically, even in a case where the threshold is configured as 100, the ratio of the execution count of NFC sessions indicated by the threshold is 1% in a case where the total execution count of NFC sessions is 10000. This is inappropriate for an analysis including determining the NFC antenna 121 that frequently performs NFC,

Consequently, in a case where the analysis is performed that involves only the comparison of the execution count with the prescribed threshold, the threshold needs to be configured to be suitable for the total execution count, leading to an increased burden on the manager of the client device 1. Therefore, the client device 1 preferably performs the analysis using the ratio of the execution count as described in the first embodiment.

### Second Embodiment

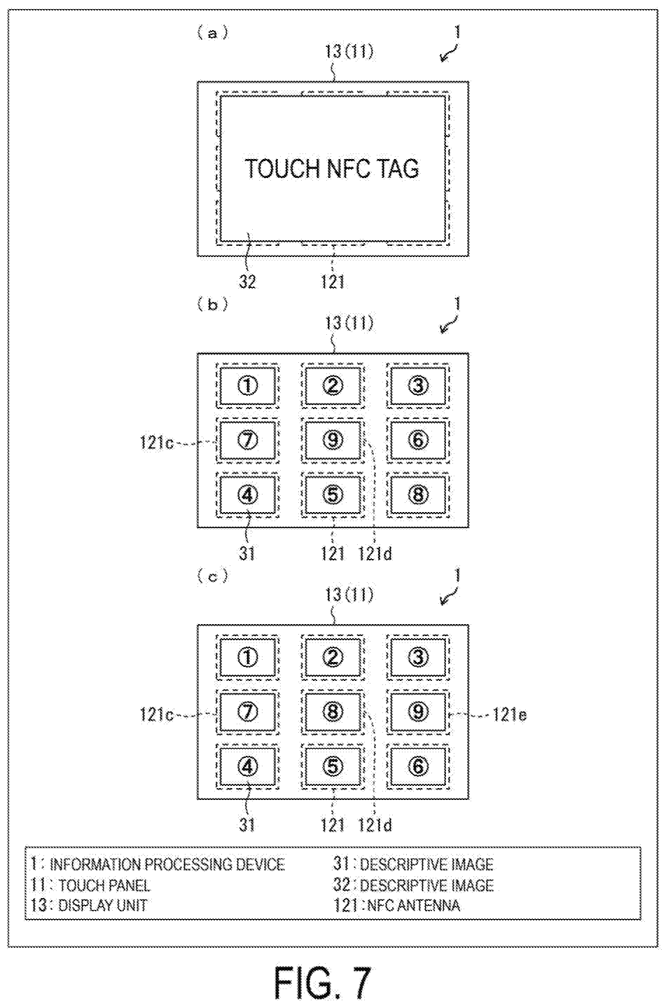

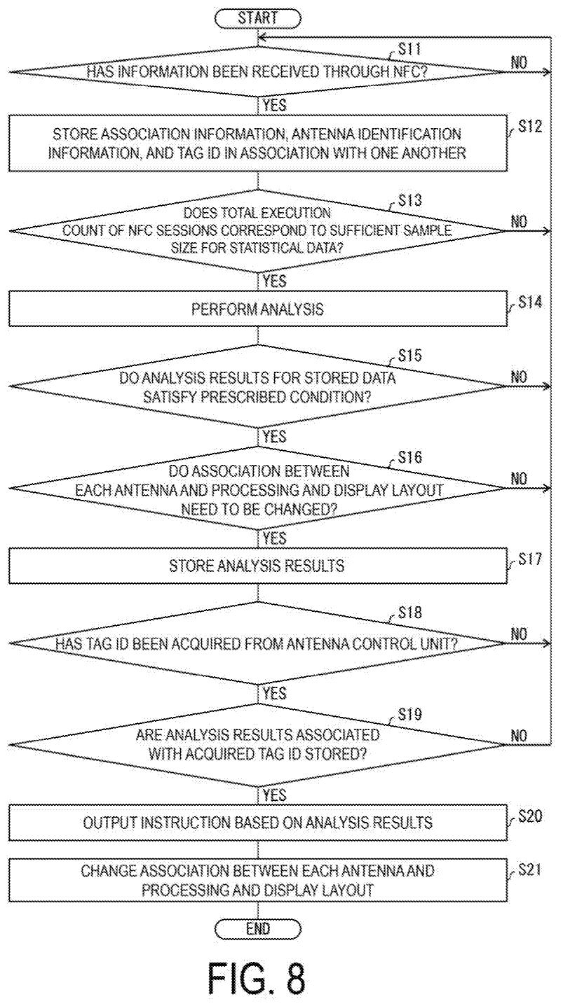

Another embodiment of the present invention will be described below with reference to FIG. 7 and FIG. 8. Note that, for convenience of description, components having the same functions as those of the components illustrated in the above-described embodiment are designated by the same reference numerals as the components having the same function, and the descriptions of these components will be omitted.

The antenna control unit 42 of the client device 1 according to the present embodiment outputs, in addition to the antenna identification information, a tag ID (client identification information) acquired from the NFC tag 20 and identifying the NFC tag 20, to the log generation unit 44. Furthermore, the log generation unit 44 associates the antenna identification information indicative of the NFC antenna 121 having performed NFC and the association information 51 indicative of the current association between each of the NFC antennas 121 and the processing performed by the client device 1, with the tag ID acquired from the NFC tag 20 through NFC. That is, the NFC log 53 according to the present embodiment is generated for each piece of association information 51 and includes information including the antenna identification information associated with the tag ID.

Associating the antenna identification information and the association information 51 with the tag ID enables the analysis unit 45 to perform an analysis using the tag ID. Specifically, the analysis unit 45 refers to the tag ID and the antenna identification information stored in the NFC log 53 to determine the count of NFC sessions via each NFC antennas 121 (communication count) for each tag ID. The analysis unit 45 then divides the determined communication count by the total communication count to determine, for each NFC antenna 121, the ratio of the communication count for each tag ID to the total communication count of NFC sessions. Consequently, the analysis unit 45 can determine frequently utilized processing for each tag ID (i.e., for each user).

Now, processing specific to the present embodiment will be described in detail with reference to FIG. 7. FIG. 7 is a diagram illustrating an example of a change in a display layout according to the second embodiment. In a case where analysis results for the information stored in the NFC log 53 satisfy a prescribed condition and the association needs to be changed, the analysis unit 45 according to the present embodiment temporarily stores the analysis results in association with the tag ID. The analysis results may be temporarily held by the analysis unit 45 or temporarily stored in the storage unit 15. Before the NFC is performed that allows the user's desired processing (i.e., one of the different types of processing labeled “1” to “9” illustrated in (b) in FIG. 7) to be performed, the client device 1 according to the present embodiment lets the user touch the NFC tag 20 to perform the NFC as illustrated in (a) of FIG. 7. Consequently, the client device I can acquire the tag ID and thus determine the tag ID before displaying a screen illustrated in (b) of FIG. 7 on the display unit 13. The antenna control unit 42 outputs the acquired tag ID to the analysis unit 45. The direct acquisition of the tag ID from the antenna control unit 42 triggers the determination, by the analysis unit 45, of whether an analysis result associated with the tag ID identical to the acquired tag ID exists in the stored analysis results. In a case where such analysis result exists, the analysis unit 45 updates the association information 51, based on the analysis result and also changes the layout information 52 indicative of the display layout of the descriptive images 31, based on the change in the association. The analysis unit 45 outputs the association change instruction to the antenna control unit 42, and outputs the layout change instruction to the display control unit 46. In a case of receiving the association change instruction, the antenna control unit 42 reads the association information 51 from the storage unit 15, and changes the association between each of the NFC antennas 121 and the processing performed by the client device 1. In a case of receiving the layout change instruction, the display control unit 46 reads the layout information 52 from the storage unit 15 and changes the display layout of the descriptive images 31. The analysis of the analysis unit 45 described in the present embodiment is merely an example and is not limited to this example.

Consequently, after NFC is performed in the state illustrated in (a) of FIG. 7, an image illustrated in (b) of FIG. 7 or (c) of FIG. 7 is displayed on the display unit 13. For example, in a case where the analysis result indicates that each of the ratio of the communication count for the NFC antenna 121 associated with the processing labeled “7” and the ratio of the communication count for the NFC antenna 121 associated with the processing labeled “9” exceeds the prescribed threshold, the analysis result indicates that the user frequently performs the processing labeled “7” and “9”. Therefore, as illustrated in (b) of FIG. 7, by associating the processing labeled “7” and the processing labeled “9” with the NFC antenna 121c and the NFC antenna 121d, respectively, the client device 1 according to the present embodiment can achieve the association between each of the NFC antennas 121 and the processing performed by the client device 1 and the display layout of the descriptive images 31, which are preferable for the user.

Furthermore, in a case where the manager desires that the user performs the processing labeled “8”, the client device 1 according to the present embodiment associates the processing “7” and the processing “9” frequently performed by the user with the NFC antenna 121c and the NFC antenna 121e, respectively, and associates the processing labeled “8” with the NFC antenna 121d located between the NFC antenna 121c and the NFC antenna 121e, as illustrated in (c) of FIG. 7. Since the user frequently performs the processing labeled “7” and the processing labeled “9”, the user is expected to perform NFC for the processing “7” and the processing “9” even in a case where the NFC antennas 121 used to perform the processing “7” and the processing “9” are located away from each other. By associating the processing “8” with the NFC antenna 121d located between the NFC antenna 121c and the NFC antenna 121d, the client device 1 according to the present embodiment can achieve the association between each of the NFC antennas 121 and the processing performed by the client device 1 and the display layout of the descriptive images 31, which are preferable for the user, and can motivate the user to perform the processing desired to be performed. That is, the client device 1 according to the present embodiment can achieve not only the association and the display layout preferable for the user of the client device 1 but also the association and the display layout preferable for the manager of the client device 1.

### Flow of Analysis Processing

Now, a flow of the analysis processing performed by the client device 1 will be described with reference to FIG. 8. FIG. 8 is a flowchart illustrating an example of the flow of the analysis processing performed by the client device 1. Note that steps S11, S13 to S16, S20, and S21 in FIG. 8 are processing similar to steps S1 and S3 to S8 in FIG. 6, respectively, and thus, the descriptions thereof will be omitted.

In a case of receiving, from the antenna control unit 42, the notification indicating that communication with the NFC tag 20 has been performed, the log generation unit 44 stores the antenna identification information, the association information 51, and the tag ID in association with one another (S12). Specifically, the log generation unit 44 reads the association information 51 from the storage unit 15, associates the association information 51 with the antenna identification information and the tag ID acquired from the antenna control unit 42, and stores the associated three types of information in the NFC log 53 stored in the storage unit 15 (the log generation unit 44 updates the NFC log 53). After updating the NFC log 53, the log generation unit 44 outputs the notification indicative of the update to the analysis unit 45.

In a case where the association and the display layout need to be changed (YES in S16), the analysis unit 45 stores the analysis results in association with the tag ID (S17). The analysis unit 45 is then made to wait to acquire a tag ID from the antenna control unit 42 (S18).

In a case of acquiring the tag ID from the antenna control unit 42 (YES in S18), the analysis unit 45 determines whether the stored analysis results include the acquired tag ID (S19). In a case where the analysis results do not include the acquired tag ID (NO in S19), the analysis unit 45 temporarily terminates the analysis processing, and the client device I waits to receive information through the next NFC (i.e., the client device 1 returns to S11).

On the other hand, in a case where the analysis results include the acquired tag ID (YES in S19), the analysis unit 45 updates the association information 51, based on the change in the association and also updates the layout information 52, based on the change in the association. The analysis unit 45 outputs the association change instruction for the change in the association between each of the NFC antennas 121 and the processing to the antenna control unit 42, and also outputs the layout change instruction for the change in the display layout of the descriptive images 31 to the display control unit 46 (S20).

As described above, the client device 1 according to the present embodiment can achieve the association and the display layout suitable for each user by utilizing the tag ID for the analysis. Furthermore, in the present embodiment, the example is described in which the count of NFC sessions via each NFC antenna 121 (communication count) is determined for each tag ID to determine frequently utilized processing for each user, but the present embodiment is not limited to this example. For example, the client device 1 may determine the user's tendency of utilization of NFC (e.g., the user performing the processing labeled “1” often concurrently performs the processing labeled. “2”, or the like) by analyzing a match rate for the tag ID associated with the antenna identification information indicative of each NFC antenna 121 (i.e., to what degree the tag ID associated with the antenna identification information indicative of one of the NFC antennas 121 matches the tag ID associated with the antenna identification information indicative of another NFC antenna 121).

Furthermore, in the present embodiment, the NFC log 53 may be a plurality of databases generated for the respective pieces of association information 51 and for the respective tag IDs. This enables a reduction in the time needed for the analysis allowing achievement of the association and the display layout suitable for each user.

### Modification of Second Embodiment

The information acquired from the NFC tag 20 by the client device 1 and associated with the antenna identification information and the association information 51 is not limited to the tag ID. For example, instead of the tag ID, personal information enabling the user of the NFC tag 20 to be identified (e.g., the user's name) may be acquired. For example, in a case where a certain user stops using the NFC tag 20, the tag ID used by the user may be assigned to another user having newly started to use the NFC tag 20. Thus, the same tag ID does not necessarily belong to the same user. Thus, in a case where the association between each of the NFC antennas 121 and the processing performed by the client device 1 and the display layout of the descriptive images 31 are changed based on the analysis using the tag ID, the changed association and display layout may not be preferable for the user. In contrast, the use of the user's name allows the client device 1 to eliminate the need for a log of NFC performed by another user with the same tag ID. Furthermore, association of the user's name with the antenna identification information and the association information 51 allows the client device 1 to identify the performing of NFC by the same user even in a case where the tag ID is changed during processing. As a result, the association and the display layout can be made preferable for the user and manager of the client device 1.

Furthermore, by acquiring personal information such as generation and gender in addition to the information such as the user's name which identifies the user, the client device 1 can perform the analysis based on a classification made according to the generation and gender. Consequently, the association between each of the NFC antennas 121 and the processing performed by the client device 1 and the display layout of the descriptive images 31 can be configured according to the generation and gender. For example, the client device I can determine that the user attempting to perform NFC is a child, and in such a case, the NFC antennas located at positions easily utilized by children (e.g., the NFC antennas 121 in the lowermost stage in FIG. 4 and FIG. 5) can be associated with frequently utilized processing.

Furthermore, the present embodiment is not limited to the configuration in which the personal information is acquired from the NFC tag 20. For example, in a case where the client device 1 includes a fingerprint authentication unit for fingerprint authentication (not illustrated) or the user operates the touch panel 11 to input a password, the client device 1 can acquire fingerprint information or a string indicative of the password as the personal information to identify the user.

### Third Embodiment

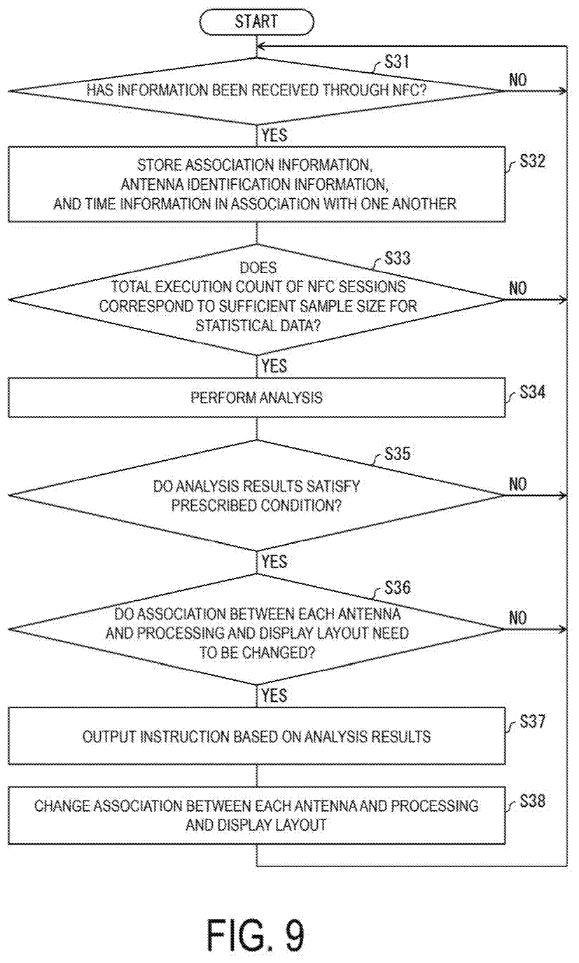

Still another embodiment of the present invention will be described below with reference to FIG. 9. Note that, for convenience of description, components having the same functions as those of the components illustrated in the above-described embodiments are designated by the same reference numerals as the components having the same function, and the descriptions of these components will be omitted.

In a case of acquiring information from the NFC antenna 121, the antenna control unit 42 of the client device 1 according to the present embodiment determines time of the acquisition of the information and outputs time information indicative of the time to the log generation unit 44 along with the antenna identification information. The log generation unit 44 further associates the antenna identification information indicative of the NFC antenna 121 having performed NFC and the association information 51 indicative of the current association between each of the NFC antennas 121 and the processing performed by the client device 1, with the time information acquired from the antenna control unit 42. That is, the NFC log 53 according to the present embodiment is generated for each piece of association information 51 and includes information including the antenna identification information associated with the time information.

Associating the antenna identification information and the association information 51 with the time information as described above allows the analysis unit 45 to perform an analysis using the time information. Specifically, the analysis unit 45 refers to the time information to determine the count of NFC sessions via each NFC antennas 121 (communication count) during each time period. The analysis unit 45 then divides the determined communication count by the total communication count to determine, for each NFC antenna 121, the ratio of the count of NFC sessions during each time period to the total communication count of NFC sessions. Consequently, the analysis unit 45 can determine a change in the usage frequency of each type of processing for each time period. Thus, changing the association between each of the NFC antennas 121 and the processing performed by the client device 1 and the display layout of the descriptive images 31 for each time period achieves the association and the display layout preferable for users for every time period.

### Flow of Analysis Processing

Now, a flow of the analysis processing performed by the client device will be described with reference to FIG. 9. FIG. 9 is a flowchart illustrating an example of the flow of the analysis processing performed by the client device I. Note that steps S31 and S33 to S38 in FIG. 9 are processing similar to step S1 and S3 to S8 in FIG. 6, respectively, and thus, the descriptions thereof will be omitted.

In a case of receiving, from the antenna control unit 42, the notification indicating that communication with the NFC tag 20 has been performed, the log generation unit 44 stores the antenna identification information, the association information 51, and the time information in association with one another (S32). Specifically, the log generation unit 44 reads the association information 51 from the storage unit 15, associates the association information 51 with the antenna identification information and the time information acquired from the antenna control unit 42, and stores the associated three types of information in the NFC log 53 stored in the storage unit 15 (the log generation unit 44 updates the NFC log 53). After updating the NFC tog 53, the log generation unit 44 outputs the notification indicative of the update to the analysis unit 45.

As described above, the client device 1 according to the present embodiment can determine the tendency of the user's utilization of NFC for each time period by associating, with the time information, the antenna identification information indicative of the NFC antenna 121 having performed NFC and the association information 51 indicative of the current association between each of the NFC antennas 121 and the processing performed by the client device 1. For example, the client device 1 can change the association between each of the NFC antennas 121 and the processing performed by the client device 1 and the display layout of the descriptive images 31 at time intervals such as each time period of the day, each day of the week, or each month of the year.

Furthermore, with a combination of the configuration of the second embodiment with the configuration of the present embodiment, the client device 1 can associate the antenna identification information with the tag ID and the time information and store the associated three types of information in the NFC tog 53 for the current association. This enables, for NFC performed by the same user, determination of the tendency of utilization of NFC with the time period varied, thus allowing determination of more minute changes in the tendency of utilization. Consequently, a more minute change can be made to the association between each of the NFC antennas 121 and the processing performed by the client device 1 and to the display layout of the descriptive images 31.

With a combination of the configuration of a modification of the second embodiment with the configuration of the present embodiment, the client device 1 can associate the antenna identification information with the personal information (the user's name, generation, gender, and the like) and the time information and store the associated three types of information in the NFC log 53 for the current association. Consequently, a more minute change can be made to the association between the NFC antennas 121 and the processing performed by the client device 1 and to the display layout of the descriptive images 31. For example, during a certain time period, many children utilize NFC, and thus, the NFC antennas 121 located at positions easily utilized by children (e.g., the NFC antennas 121 in the lowermost stage in FIG. 4 and FIG. 5) can be associated with frequently utilized processing.

### Fourth Embodiment

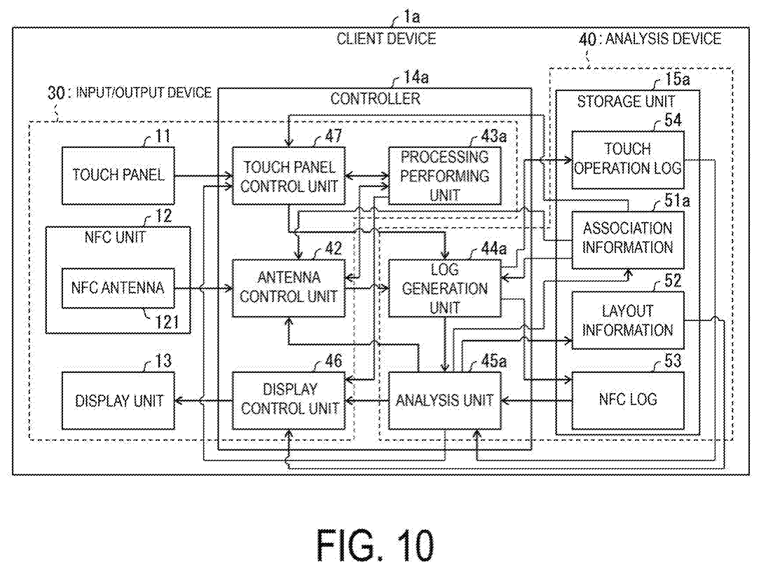

Still another embodiment of the present invention will be described below with reference to FIGS. 10 to 12. Note that, for convenience of description, components having the same functions as those of the components illustrated in the above-described embodiments are designated by the same reference numerals as the components having the same function, and the descriptions of these components will be omitted.

First, functions of a client device 1a (analysis device, information processing device) according to the present embodiment will be described in brief. The terminal 1a changes, in addition to the association between each of the NFC antennas 121 and the processing performed by the client device 1a, an association between a plurality of areas in the touch panel 11 where the touch operation can be performed (hereinafter referred to as operation areas) and the different types of processing performed by the client device 1a.

FIG. 10 is a block diagram illustrating an example of a primary configuration of the client device 1a. Unlike the client device 1 described in the first embodiment, the client device 1a includes a controller 14a instead of the controller 14. Furthermore, the client device 1a includes a storage unit 15a instead of the storage unit 15.

Unlike the controller 14 described in the first embodiment, the controller 14a includes a processing performing unit 43a instead of the processing performing unit 43. The controller 14a also includes a log generation unit 44a instead of the log generation unit 44. The controller 14a also includes an analysis unit 45a instead of the analysis unit 45. The controller 14a also includes a touch panel control unit 47 instead of the operation determination unit 41.

### Touch Panel Control Unit 47

In addition to providing the functions of the operation determination unit 41 described in the first embodiment, the touch panel control unit 47 outputs, to the log generation unit 44a, area information indicative of an area where the touch operation has been performed and a notification indicating that the touch operation has been performed. The touch panel control unit 47 changes the processing associated with each of the areas configured in the touch panel 11 (input unit) in accordance with an instruction from the analysis unit 45 or the processing performing unit 43. Detailed description of these operations will be given below.

### Processing Performing Unit 43a

In addition to providing the functions of the processing performing unit 43a described in the first embodiment, the processing performing unit 43 outputs, to the touch panel control unit 47, an instruction for a change in the association between each of the above-described operation areas and the processing performed by the client device 1a. For example, in a case where the association needs to be changed, e.g., as a result of performing of display screen changing processing by the processing performing unit 43, the processing performing unit 43a updates area association information included in association information 51a stored in the storage unit 15a and instructs the touch panel control unit 47 to change the association. Note that the association information 51a includes information indicative of the association between the antenna identification information on each NFC antenna 121 and the contents of the processing performed in conjunction with NFC performed via the NFC antenna 121 indicated by the antenna identification information (in the present embodiment, referred to as antenna association information. Furthermore, the association between each of the NFC antennas 121 and the processing performed by the client device 1 is referred to as antenna association) as described in the first embodiment, and area association information indicative of an association between area information indicative of each of the above-described operation areas and the contents of the processing performed in conjunction with the touch operation performed on the area indicated by the area information,

### Log Generation Unit 44a

In addition to providing the functions of the log generation unit 44 described in the first embodiment, in a case of acquiring, from the touch panel control unit 47, a notification indicating that the touch operation has been performed and the area information indicative of the area where the touch operation has been performed, the log generation unit 44 associates the area information with the area association information included in the association information 51a, and stores the associated two types of information to the touch operation log 54 (the log generation unit 44a updates a touch operation log 54). The log generation unit 44a then outputs a notification indicating that the touch operation log 54 has been updated to the analysis unit 45a. Note that the touch operation log 54 indicates, in chronological order, correspondence relations between each of the areas where the touch operation has been performed and the processing associated with the area at the time of the performing of the touch operation, in other words, a log of performing of the touch operation. Note that, like the NFC log 53, the touch operation tog 54 is generated as a new file in a case where the association between each of the areas and the processing of the client device 1a is changed. Thus, the touch operation log 54 is generated for each piece of area association information.

### Analysis Unit 45a

In addition to providing the functions of the analysis unit 45 described in the first embodiment, the analysis unit 45a outputs analysis results used to determine the association between each of the areas in the touch panel 11 and the processing performed by the client device 1 (hereinafter referred to as the area association) and the display layout. Details of the analysis are similar to those of the analysis described in the first embodiment except for the use of the touch operation tog 54, and thus, the descriptions thereof will be omitted.

### Storage Unit 15a

Unlike the storage unit 15 described in the first embodiment, the storage unit 15a stores the association information 51a instead of the association information 51. The storage unit 15a newly stores the touch operation log 54. Note that, since the association information 51a and the touch operation log 54 have already been described, the descriptions thereof will be omitted.

Changes in Association and Display Layout based on Analysis

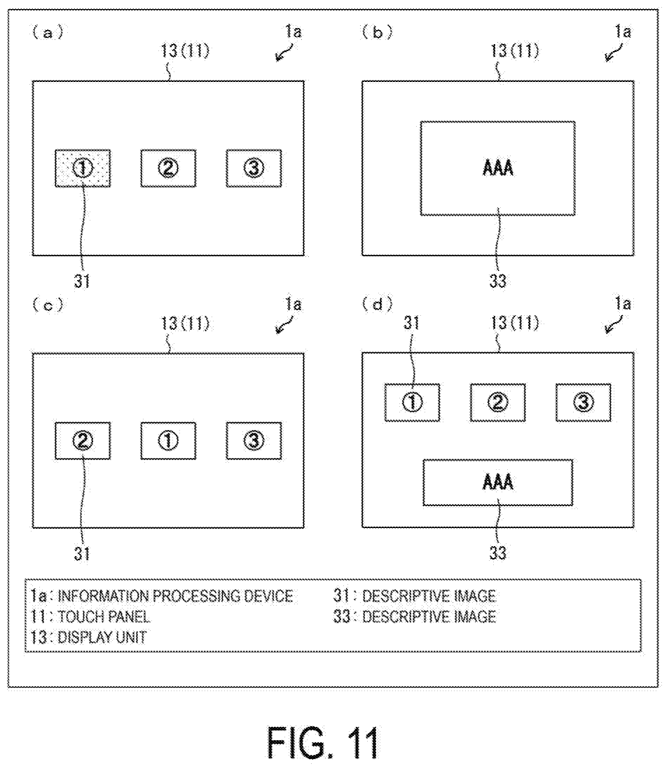

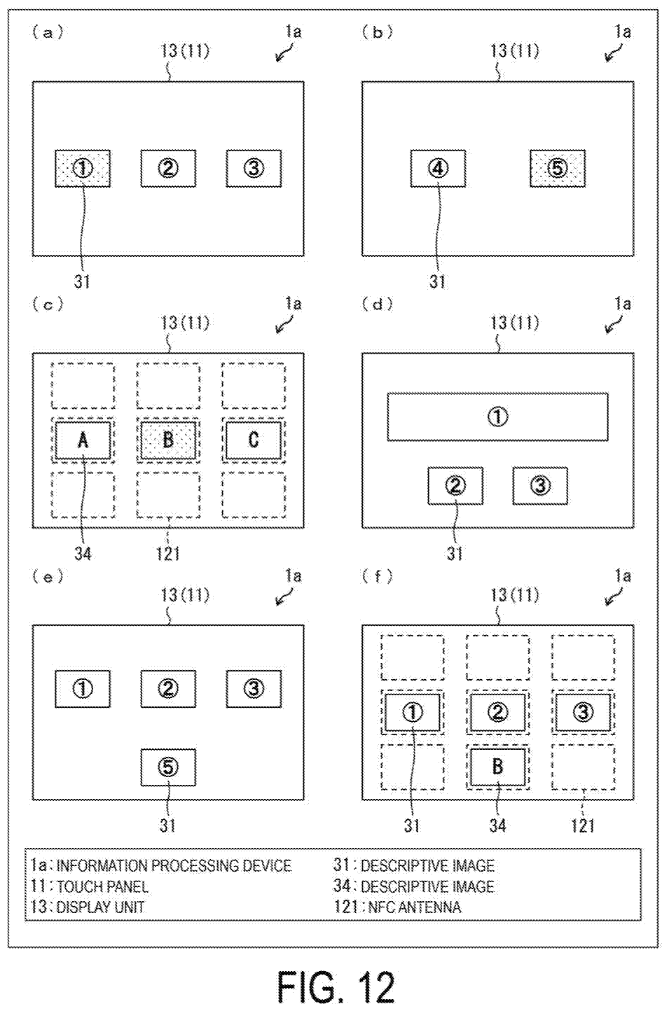

Now, with reference to FIG. 11 and FIG. 12, details of changes in the association and the display layout performed by the client device 1a according to the present embodiment will be described. FIG. 11 is a diagram illustrating an example of a change in the display layout according to the present embodiment, and FIG. 12 is a diagram illustrating another example of a change in the display layout according to the present embodiment.

First, with reference to FIG. 11, changes in the area association and the display layout using only operation information will be described. (a) of FIG. 11 illustrates the display layout of the descriptive images 31 before the analysis, and illustrates the descriptive images 31 indicating the different types of processing labeled “1” to “3” being displayed at positions on the display unit 13 that overlap the respective areas in the touch panel associated with the processing “1” to the processing “3”. Note that, in (a) of FIG. 11, the area associated with the processing labeled “2” is assumed to be the area most conveniently utilized (most easily touched) by the user. Furthermore, in a case where the user touches the area associated with the processing “1” the area where the image indicating the processing “1” is displayed), the client device 1a performs the processing labeled “1” to display a descriptive image 33 illustrated in (b) of FIG. 11. An area on the touch panel 11 that overlaps the area where the descriptive image 33 is displayed is associated with processing labeled “AAA”.

Here, the results of the analysis performed by the analysis unit 45a are assumed to indicate that the ratio of the execution count of touch operations (hereinafter referred to as the touch count) on the area associated with the processing labeled “1” to the total execution count of touch operations (hereinafter referred to as the total touch count) in connection with the current association and display layout exceeds the prescribed threshold. This indicates that, of the different types of processing “1” to “3”, the processing “1” is frequently utilized by the user. The analysis unit 45a refers to the area association information to determine whether the area association and the display layout need to be changed (in this case, the analysis unit 45a determines that the area association and the display layout need to be changed). The analysis unit 45a then updates the area association information included in the association information 51a such that the area associated with the processing “2” in (a) FIG. 11 (i.e., the area most conveniently utilized by the user) is associated with the processing labeled “1”. Furthermore, based on the change in the association, the analysis unit 45a changes the layout information 52. In the example in (a) of FIG. 11, the layout information 52 is information indicative of a display layout where the display position of the descriptive image 31 indicating the processing “1” is a position that overlaps the area associated with the processing “2” in (a) of FIG. 11. The analysis unit 45a outputs an area association change instruction for a change in the association between each of the operation areas and the processing to the touch panel control unit 47 to causes the touch panel control unit 47 to change the association between each of the operation areas and the processing performed by the client device 1. The analysis unit 45a outputs a layout change instruction for a change in the display layout of the descriptive images 31 to the display control unit 46 to cause the display control unit 46 to change the display layout of the descriptive images 31. Consequently, of the three areas associated with the respective types of processing labeled “1” to “3” as illustrated in (c) of FIG. 11, the area associated with the processing “2” in (a) of FIG. 11 is associated with the processing labeled “1”. Consequently, the area most conveniently utilized by the user can be associated with the processing most frequently utilized by the user.

Furthermore, in a case where the ratio of the execution count of touch operations (hereinafter referred to as the touch count) on the area associated with the processing labeled “1” exceeds a prescribed threshold, the analysis unit 45a may update the area association information included in the association information 51a and update the layout information 52 based on the change in the association such that the processing “AAA” can be performed on a screen where the different types of processing “1” to “3” can be performed as illustrated in (d) of FIG. 11. In this example, the layout information 52 is information indicative of the display layout of the descriptive images 31 and the descriptive image 33 illustrated in (d) of FIG. 11. The analysis unit 45a outputs the area association change instruction to the touch panel control unit 47 to allow the touch panel control unit 47 to change the association between each of the operation areas and the processing performed by the client device 1. The analysis unit 45a outputs the layout change instruction for a change in the display layout of the descriptive images 31 and the descriptive image 33 to the display control unit 46 to cause the display control unit 46 to change the display layout of the descriptive images 31. This enables a reduction in the user's touch count preceding performing of the processing “AAA” frequently utilized by the user, thus achieving the association and the display layout that are convenient for the user.

Now, with reference to FIG. 12, changes in the area association and the display layout using the ratio of the touch count and the ratio of the execution count of NFC sessions via the NFC antenna 121 (communication count) will be described.

(a) to (c) of FIG. 12 are diagrams illustrating the association and the display layout before the analysis. On the screen illustrated in (a) of FIG. 12, the user most frequently touches the area associated with the processing “1”. Touching the area associated with the processing “1” is assumed to allow a screen illustrated in (b) of FIG. 12 to be displayed. Furthermore, on the screen illustrated in (b) of FIG. 12, the user most frequently touches the area associated with the processing “5”. Touching the area associated with the processing “5” is assumed to allow a screen illustrated in (c) of FIG. 12 to be displayed. On the screen illustrated in (c) of FIG. 12, the descriptive images 34 indicating the respective types of processing “A” to “C” are displayed in such a manner as to overlap the NFC antennas 121 associated with the respective types of processing “A” to “C”. Here, the processing most frequently utilized by the user is assumed to be the processing labeled “B” (i.e., the NFC antenna 121 over which the user most frequently holds the NFC tag 20 is the NFC antenna 121 associated with the processing “B”).

Furthermore, the results of the analysis by the analysis unit 45 are assumed to indicate that the ratio of the touch count for the area most frequently touched on each screen and the ratio of the execution count of NFC sessions (communication count) using the NFC antenna 121 via Which NFC is most frequently performed exceed the respective prescribed thresholds.

As a result of the above-described analysis, the analysis unit 45a updates the area association information included in the association information 51a in such a manner as to provide, e.g., the area association illustrated in (d) of FIG. 12. Furthermore, based on the change in the association, the analysis unit 45a changes the layout information 52. The analysis unit 45a outputs the area association change instruction for a change in the association between each of the operation areas and the processing to the touch panel control unit 47 to cause the touch panel control unit 47 to change the association between each of the operation areas and the processing performed by the client device 1. Consequently, the area associated with the processing “1” is widened to allow the user to more easily perform the touch operation for performing the processing “1”. Furthermore, the analysis unit 45a may update the area association information included in the association information 51a in such a manner as to provide the area association illustrated in (e) of FIG. 12, and update the layout information 52 based on the change in the association. Consequently, the first touch operation enables the client device 1 to perform the processing “5”, thus enabling a reduction in the count of touch operations performed by the user.

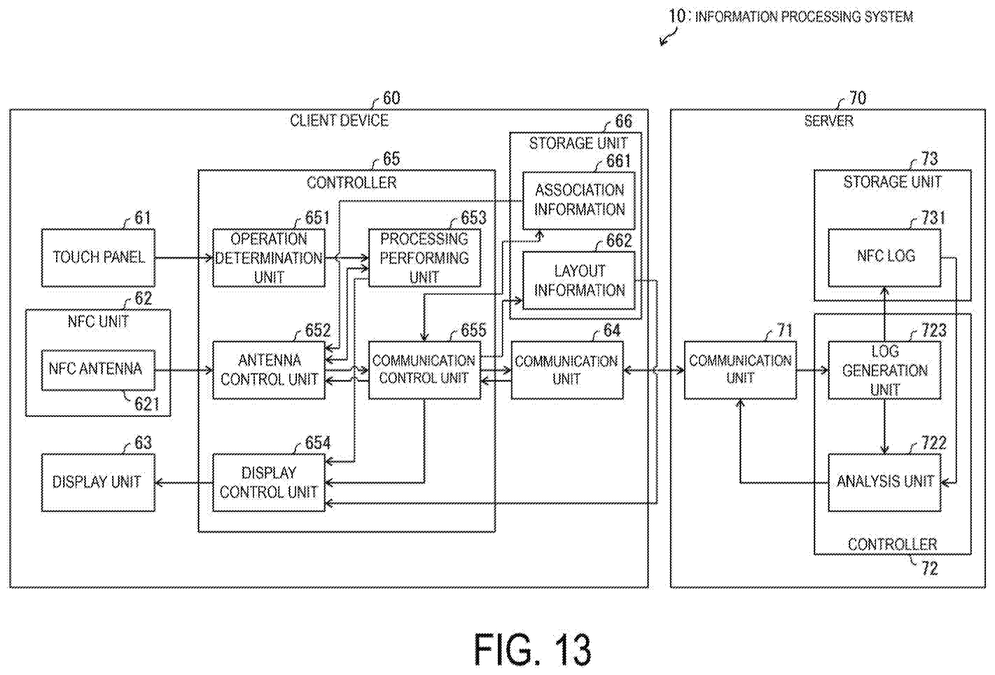

Furthermore, the analysis unit 45a may update the area association information included in the association information 51a and the antenna association information in such a manner as to provide the area association and the antenna association illustrated in (t) of FIG. 13, and update the layout information 52 based on the change in the association. Consequently, a desired NFC can be performed on the first screen (i.e., the processing “B” can be performed), thus enabling the user to perform the desired NFC without performing any touch operation. Therefore, the amount of time until one user successfully performs the desired NFC can be reduced.

As described above, not only does the client device 1a according to the present embodiment change the association between each of the NFC antennas 121 and the processing and the display layout but the client device 1a also performs the analysis allowing for changes in the display layout and the association between each of the areas in the touch panel 11 and the processing. This enables a reduction in the time needed for the touch operation and thus in the user's burdens.

Furthermore, the analysis for a change in the association between each of the areas in the touch panel 11 and the processing performed by the client device 1a is also applicable to a client device not including the NFC unit 12. Consequently, in the client device including the display on which the touch operation can be performed, the association between each of the areas and the processing and the display layout of the descriptive images can be achieved that are preferable for the user, and the time needed for the touch operation can be reduced. Note that, in the client device not including the NFC unit 12, the controller of the client device is configured not to include the antenna control unit 42.

### Fifth Embodiment

Still another embodiment of the present invention will be described below with reference to FIG. 13. Note that, for convenience of description, components having the same functions as those of the components illustrated in the above-described embodiments are designated by the same reference numerals as the components having the same function, and the descriptions of these components will be omitted.

In the above-described first to fourth embodiments, each of the client devices 1 and 1a includes the input/output device 30 and the analysis device 40 integrated together. In the present embodiment, a configuration including the input/output device 30 and the analysis device 40 separated from each other is described below. FIG. 13 is a block diagram illustrating an example of a primary configuration of a client device 60 (information processing device) and a server 70 (analysis device) included in an information processing system 10 according to the present embodiment.

### Client Device 60

The client device 60 is a device corresponding to the input/output device 30 described in the first embodiment. Specifically, the client device 60 performs processing corresponding to the user's touch operation and transmission and/or reception of information to and/or from the NFC tag 20 in conjunction with performing of NFC, and displays images corresponding to the processing. The client device 60 includes a touch panel 61, an NFC unit 62, a display unit 63, a communication unit 64, a controller 65, and a storage unit 66. Note that the touch panel 61, the NFC unit 62, and the display, unit 63 are similar to the touch panel 11, the NFC unit 12, and the display unit 13 described in the first embodiment, and thus, the descriptions thereof will be omitted,

### Communication Unit 64

The communication unit 64 serves as a communication device configured to transmit and/or receive information to and/or from the server 70. The communication unit 64 may be any communication device so long as the communication unit can transmit and/or receive information to and/or from the server 70, and information may be transmitted and/or received by wired communication or by wireless communication. However, the wired communication limits the installation location of the server 70, and thus, the wireless communication is preferable.

### Controller 65

The controller 65 collectively controls functions of the client device 60. The controller 65 includes an operation determination unit 651, an antenna control unit 652, a processing performing unit 653, a display control unit 654, and a communication control unit 655. Note that the operation determination. unit 651 and the processing performing unit 653 are similar to the operation determination unit 41 and the processing performing unit 43 described in the first embodiment, and thus, the descriptions thereof will be omitted.

In a case of acquiring information from one of the NFC antennas 121, the antenna control unit 652 outputs, to the communication control unit 655, a notification indicating that communication with the NFC tag 20 has been performed and antenna identification information indicating the NFC antenna 121 having performed NFC with the NFC tag 20. Furthermore, the antenna control unit 652 acquires the association change instruction from the communication control unit 655. The other functions are similar to the corresponding functions of the antenna control unit 42 described in the first embodiment.

The display control unit 654 is similar to the display control unit 46 described in the first embodiment except that the display control unit 654 acquires the layout change instruction from the communication control unit 655.

The communication control unit 655 controls the communication unit 64 to transmit and/or receive information to and/or from the server 70. Specifically, in a case of receiving, from the antenna control unit 652, the notification indicating that communication with the NFC tag 20 has been performed, the communication control unit 655 reads association information 661 stored in the storage unit 66. The communication control unit 655 then transmits the antenna identification information acquired from the antenna control unit 652 and indicating the NFC antenna 121 via which NFC has been performed and the read association information 661 indicative of the association between each of the NFC antennas 121 and the processing performed by the client device 1 at the time of performing of the NFC, to the server 70 via the communication unit 64. The association information 661 is similar to the association information 51 described in the first embodiment, and thus, the description thereof will be omitted.

Furthermore, in a case of receiving the association change instruction and the layout change instruction via the communication unit 64, the communication control unit 655 updates the association information 661 and the layout information 662, based on the instructions. The communication control unit 655 outputs the association change instruction and the layout change instruction to the antenna control unit 652 and the display control unit 654, respectively. The layout information 662 is similar to the layout information 52 described in the first embodiment, and thus, the description thereof will be omitted.

### Storage Unit 66

The storage unit 66 stores various types of data used by the client device 60. The storage unit 66 stores at least the association information 661 and the layout information 662. The association information 661 and the layout information 662 have already been described, and thus the descriptions thereof will be omitted.

### Server 70

The server 70 is a device corresponding to the analysis device 40 described in the first embodiment. Specifically, the server 70 analyzes an NFC log 731 storing the antenna identification information and the association information 51 received from the client device 60, and transmits the association change instruction for a change in the association between each of the NFC antennas 621 and the processing and the layout change instruction for a change in the display layout of the images (descriptive images 31) on the display unit 13, to the client device 60 as necessary. The server 70 includes a communication unit 71, a controller 72, and a storage unit 73.

### Communication Unit 71

The communication unit 71 serves as a communication device configured to transmit and/or receive information to and/or from the client device 60. The communication unit 71 may be any communication device so long as the communication unit can transmit and/or receive information to and/or from the client device 60, and information may be transmitted and/or received by wired communication or by wireless communication. However, the wired communication limits the installation location of the server 70, and thus, the wireless communication is preferable.

### Controller 72

The controller 72 collectively controls functions of the server 70. The controller 72 includes an analysis unit 722 and a log generation unit 723. The log generation unit 723 receives, via the communication unit 71, the antenna identification information indicative of the NFC antenna 121 having performed NFC and the association information 661 indicative of the current association between each of the NFC antennas 121 and the processing performed by the client device 60, the antenna identification information and the association information 661 being transmitted from the client device 60. The log generation unit 723 then stores the antenna identification information and the association information 661 in the NFC log 731 in association with each other (the log generation unit 723 updates the NFC log 731). The other functions are similar to the corresponding functions of the log generation unit 44 described in the first embodiment.

Furthermore, the analysis unit 722 is similar to the analysis unit 45 described in the first embodiment except that the analysis unit 722 transmits the association change instruction, the layout change instruction, and the layout information 662 to the client device 60 via the communication unit 71.

### Storage Unit 73

The storage unit 73 stores various types of data used by the server 70. The storage unit 73 stores at least the NFC log 731. The NFC log 731 is similar to the NFC log 53 described in the first embodiment, and thus, the description thereof will be omitted.

The server 70 may be configured to be able to communicate with a plurality of the client devices 60. Furthermore, in a case where the communication unit 71 communicates with the client device 60 by wireless communication, the server 70 can communicate with the client device 60 installed in a facility different from a facility where the server 70 is grounded.

In a case where the server is configured to be able to communicate with a plurality of the client devices 60, the server 70 can perform an analysis based on NFC performed by each of the client devices 60. In a case where the server is configured to be able to communicate with a plurality of the client devices 60, information stored in the NFC log 731 preferably includes the antenna identification information, the association information 661, and information for identifying the client device 60 that are associated with one another.

For example, in a case where one of the client devices 60 (hereinafter referred to as the client device 60a) is configured to perform processing for transmitting information on a product to the NFC tag 20 through NFC, and another of the client devices 60 (hereinafter referred to as the client device 60b) is configured to perform payment processing for the product through NFC, the information processing system 10 according to the present embodiment can determine a correlation between information acquisition and actual purchase by performing an analysis based on a log of NFC performed by the client device 60a and a log of NFC performed by the client device 60b. This enables a change in the display layout of the descriptive images 31 and in the association between the NFC antennas 121 of the client device 60a and the client device 60b and the different types of processing performed by the client devices 60a and 60b, based on the determined correlation.

Furthermore, for a plurality of the client devices 60 installed at different locations and involving the same association between the NFC antennas 121 and the different types of processing performed by the respective client devices 60 and the same display layout of the descriptive images 31, the information processing system 10 according to the present invention performs an analysis by comparing the logs of NFC sessions performed by the client devices 60 to enable determination of a correlation between the installation location and the performing of NFC. Consequently, the association and the display layout can be appropriately changed according to the installation location.

Note that each client device 60 may be configured similarly to the client device 1 described in the first embodiment, i.e., each client device 60 may be configured to be able to perform analyses, like the client device 1. Consequently, in a case where an analysis is to be made based on a log of NFC performed by the client device 60, the client device 60 can perform the analysis. Note that, in a case where an analysis is to be made based on a log of NFC performed by one of the client devices 60 and a log of NFC performed by another client device 60, the server 70 may perform the analysis.

Furthermore, in the present embodiment, a configuration is described in which the client device 1 described in the first embodiment is separated into the client device 60 and the server 70. However, the configuration of the present embodiment is applicable to the embodiments other than the first embodiment (second to fourth embodiments). For example, in the configuration where the antenna identification information and the association information are stored in the NFC log 731 further associated with the personal information as in the modification of the second embodiment, the information processing system 10 can perform an analysis based on a log of NFC performed on a plurality of the client devices 60 by particular users. Therefore, the association and the display layout can more accurately be made preferable for the user. Furthermore, in the configuration where the antenna identification information and the association information are further associated with the time information, with all these types of information stored in the NFC log 731, as in the third embodiment, the information processing system 10 can perform an analysis based on a log of NFC performed on a plurality of the client devices 60 for each time period. This enables determination of the correlation between different types of processing such as the correlation between information acquisition processing and payment processing during each time period as descried above. For example, given the correlation that the information acquisition processing and the payment processing for particular products are more frequently performed in the evening, the association and the display layout may be changed only in the evening to facilitate the information acquisition and payment for the products.

### Modifications

Each of the above-described embodiments describes a configuration in which, in a case where the results of an analysis in the client devices 1 and 1a and the information processing system 10 indicate the need for a change in the association between each input area (each NFC antenna 121, each area in the touch panel 11) and the processing performed by the client devices and in the display layout of the descriptive images, the analysis unit 45, the analysis unit 45a, and the analysis unit 722 give the instruction to automatically change the association and the display layout. However, an embodiment of the present invention is not limited to this configuration. For example, the analysis unit 45, the analysis unit 45a, and the analysis unit 722 may be configured such that, in a case where the association and the display layout need to be changed, each of the analysis units output information for the changes (e.g., information indicative of the results of an analysis itself or information indicative of the changed association and display layout). The output destination of the information may be, for example, the storage unit 15 and 15a of the client device 1 and 1a and the storage unit 73 of the server 70, or to the client device 1, 1a and a personal computer of the manager of the server 70, or to the client device 1 and 1a and a printer (not illustrated) communicatively connected to the server 70. The manager manually changes the association and the display layout based on the output information.

Furthermore, in each of the above-described embodiments, the operations are performed using the touch panel 11, but the component receiving the user's operations is not limited to the touch panel 11. For example, the component may be a plurality of physical buttons provided on the client device. Note that, in a case where physical buttons are provided, the display unit 13 displays descriptive images indicating what processing is to be performed by operating the physical buttons as is the case where the touch panel 11 is provided. Consequently, an analysis can be performed based on the user's depression of the physical buttons. This enables a change in the association between each of the physical buttons and the processing performed by the client device 1 and in the display layout of the descriptive images as needed, allowing the association and the display layout to be made preferable for the user.

### Implementation Example by Software

Each of the control blocks (specifically, the controller 14, the controller 14a, the controller 65, and the controller 72) of the client devices 1 and 1a, the client device 60, and the server 70 may be implemented by a logic circuit (hardware) formed in an integrated circuit (IC chip) and the like, or may be implemented by software using a Central Processing Unit (CPU).

In the latter case, each of the client devices 1 and 1a, the client device 60, and the server 70 includes a CPU configured to perform instructions in a program that is software for implementing various functions, a Read. Only Memory (ROM) or a storage device (which are referred to as a “recording medium”) in which the program and various types of data are recorded in a computer-readable (or CPU-readable) manner, a Random Access Memory (RAM) into which the above-described program is loaded. Then, the computer (or CPU) reads the program from the recording medium and performs the program to achieve the object of the present invention. As the recording medium, a “non-transitory tangible medium”, such as a tape, a disk, a card, a semiconductor memory, and a programmable logic circuit may be used. Further, the program may be supplied to the computer via any transmission medium (a communication network, a broadcast wave, or the like) able to transmit the program. Note that an embodiment of the present invention may be implemented in a form of a data signal embedded in a carrier wave and in which the program is embodied by electronic transmission.

### Cross-Reference to Related Application

This application is based upon and claims the benefit of priority from JP 2015-220753, filed on Nov. 10, 2015, the disclosure of which is incorporated herein in its entirety by reference.

### Supplement

An analysis device (client device 1, analysis device 40, server 70) according to a first aspect of the present invention includes an analysis device configured to be communicatively connected to an information processing device (client device 1, input/output device 30, client device 60) including an input unit (touch panel 11, NFC unit 12) with a plurality of input areas (NFC antennas 121), each of the input areas being associated with processing performed by the information processing device, the analysis device including an analysis unit (analysis unit 45) configured to analyze a log of input performed on any of the input areas by an operator output from the information processing device and to determine a preferred association between each of the input areas and the processing, based on a prescribed rule.

This configuration analyzes the log of input performed on any of the input areas by the user to determine the preferred association between each of the input areas and the processing based on the prescribed rule,

Consequently, the preferred association between each of the input areas and the processing can be determined taking into account the inputs performed on the input areas by the user. Here, the prescribed rule refers to a rule for determining the association that allows an operator of the information processing device to easily perform operations or a rule for determining the association that allows the operator to easily select processing desired by a manager of the information processing device, or the like. Thus, the association between each of the input areas and the processing cart be made preferable for the operator or manager of the information processing device.

Examples of the plurality of input areas include a plurality of antennas for near field radio communication, a plurality of areas provided on the touch panel, and a plurality of physical buttons.

The analysis device according to a second aspect of the present invention includes the analysis device in the first aspect that may include an output unit configured to output, to the information processing device, a change instruction to change the association of a current time in the information processing device to an association determined by the analysis unit in a case where the association of the current time is different from the association determined by the analysis unit.

According to this configuration, the analysis device outputs the change instruction for a change in the association to the information processing device as needed, thus allowing the information processing device to automatically change the association. Therefore, the association can be easily changed.

The analysis device according to a third aspect of the present invention includes the analysis device in the second aspect wherein the information processing device may further include a display unit (display unit 13) configured to display a plurality of images indicating which of the input areas is associated with the processing, and the output unit may further output an arrangement change instruction for a change in arrangement of the images in accordance with the association determined by the analysis unit.

This configuration outputs the arrangement change instruction enabling a change in the arrangement of the plurality of images displayed on the display unit of the information processing device and indicating which of the input areas is associated with the processing, in accordance with the change in the association, thus allowing the arrangement of the images to be changed in accordance with the association. Therefore, the user can be made to recognize how the association has been changed.

The analysis device according to a fourth aspect of the present invention includes the analysis device in any one the first to third aspects wherein the association may be determined based on a relative frequency of an input operation performed on each of the plurality of input areas.

This configuration determines the association based on the relative frequency of the input operation performed on each of the input areas. The configuration can thus determine, for a certain association, an input area involving more inputs than the other input areas, i.e., a type of processing having a higher execution frequency than the other types of processing. Therefore, the association can be changed with processing taking a higher execution frequency into account.

For example, processing with a higher execution frequency can be associated with an input area located at a position conveniently utilized by user. Consequently, an input to the input area located at the position conveniently utilized by the user allows the processing with a higher frequency to be performed, thus resulting in an association preferable for the user.

The analysis device according to a fifth aspect of the present invention includes the analysis device in any one the first to third aspects wherein the analysis unit may compare relative frequency of an input operation on each of the plurality of input areas during a first period in which a first association between each of the plurality of input areas and the processing is used, with relative frequency of an input operation on each of the plurality of input areas during a second period in which a second association between each of the plurality of input areas and the processing is used, thereby determining which of the first association and the second association is preferable.

This configuration compares relative frequency of an input operation on each of the input areas during a first period in which a first association is used, with relative frequency of an input operation on each of the input areas during a second period in which a second association is used, thereby determining which of the first association and the second association is preferable. This allows determination of how the user's input frequency varies among the different associations. For example, in a case where the manager of the information processing device changes the association in expectation of an increase in the number of inputs to a particular input area, whether the number of inputs has increased as expected by the manager can be determined. Thus, based on the determination result, the association between each of the input areas and the processing can be made preferable for the manager,

The analysis device according to a sixth aspect of the present invention includes the analysis device in any one the first to fifth aspects wherein the analysis unit may use time information indicative of time of acceptance of the input by any of the input areas, to determine the association.

This configuration uses the time information to determine the association, thus allowing the analysis to be performed with the log divided into pieces according to time periods. Consequently, the association preferable for the user can be determined for each time period, and thus, the association can be changed to be different association according to the time period to provide a preferred association for every user regardless of the time period when the user utilizes the information processing device.

The analysis device according to a seventh aspect of the present invention includes the analysis device in any one the first to sixth aspects wherein the input unit may include at least a near field radio communication unit (NFC unit 12) configured to perform near field radio communication, and each of the input areas may be an antenna (NFC antenna 121) configured to perform near field radio communication.

In this configuration, the information processing device can perform near field radio communication with the client device, and thus, in the information processing device having the near field radio communication function, the association between each of the antennas and the processing can be made preferable for the user.

The analysis device according to an eighth aspect of the present invention includes the analysis device in the seventh aspect wherein the analysis unit may use client identification information for identifying the client device held over the antenna, to determine the association.

This configuration performs the analysis using the client identification information allowing identification of the client device held over the antenna and can thus estimate that a log including the same client identification information has been generated by input performed by the same user. Therefore, the preferred association can be determined for each user who utilizes the information processing device. Consequently, an information processing device can be implemented that varies the preferred association with each user.

The analysis device according to a ninth aspect of the present invention includes the analysis device in the eighth aspect wherein the client identification information may be information specifying a user of the client device.

In this configuration, the client identification information is information capable of specifying the user. Consequently, the log including the same client identification information can be determined to result from input performed by the same user, allowing the preferred association to be more accurately determined for each user who utilizes the information processing device. Note that the information capable of specifying the user to be identified is, for example, information indicating the user's name.

The analysis device according to a tenth aspect of the present invention includes the analysis device in any one the first to eighth aspects wherein the input unit may include at least a touch panel (touch panel 11), and the input areas may be areas configured on the touch panel.

In this configuration, the information processing device can accept a touch operation performed by the user, and thus, in the information processing device enabling the touch operation, the association between each of the areas on the touch panel and the processing can be made preferable for the user.

A method for controlling an analysis device according to an eleventh aspect of the present invention includes a method for controlling an analysis device communicatively connected to an information processing device including an input unit with a plurality of input areas, each of the input areas being associated with processing performed by the information processing device, the method including an analysis step of analyzing a log of input performed on any of the input areas by an operator output from the information processing device, and determining a preferred association between each of the input areas and the processing based on a prescribed rule (step S4).

This configuration produces advantageous effects similar to those of e analysis device according to the first aspect.

The analysis device according to each aspect of the present invention may be implemented by a computer. In this case, a control program for the analysis device which causes the computer to function as each unit (software module) included in the analysis device to implement the analysis device by the computer, and a computer-readable recording medium having the control program recorded therein also fall within the scope of the present invention.

The present invention is not limited to each of the above-described embodiments. It is possible to make various modifications within the scope of the claims. An embodiment obtained by appropriately combining technical elements each disclosed in different embodiments falls also within the technical scope of the present invention. Furthermore, technical elements disclosed in the respective embodiments may be combined to provide a new technical feature.

### REFERENCE SIGNS LIST

1, 1a Client device (analysis device, information processing device)

11 Touch panel (input unit)

12 NFC unit (input unit, near field radio communication unit)

13 Display unit

30 Input/output device (information processing device)

40 Analysis device

45 Analysis unit (output unit)

60 Client device (information processing device)

70 Server (analysis device)

121 NFC antenna (input area, antenna)

S4 Analysis step

1. An analysis device configured to be communicatively connected to an information processing device including an input unit with a plurality of input areas, each of the input areas being associated with processing performed by the information processing device, the analysis device comprising:
an analysis unit configured to analyze a log of input performed on any of the plurality of input areas by an operator output from the information processing device and to determine a preferred association between each of the plurality of input areas and the processing, based on a prescribed rule.

2. The analysis device according to claim 1, comprising an output unit configured to output, to the information processing device, a change instruction to change the association of a current time in the information processing device to an association determined by the analysis unit in a case where the association of the current time in the information processing device is different from the association determined by the analysis unit.

3. The analysis device according to claim 2, wherein the information processing device further comprises a display unit configured to display a plurality of images indicating which of the input areas is associated with the processing, and
the output unit further outputs, to the information processing device, an arrangement change instruction for a change in arrangement of the plurality of images in accordance with the association determined by the analysis unit.

4. The analysis device according to claim 1, wherein the analysis unit determines the association based on a relative frequency of an input operation performed on each of the plurality of input areas.

5-13. (canceled)

14. The analysis device according to claim 2, wherein the analysis unit determines the association based on a relative frequency of an input operation performed on each of the plurality of input areas.

15. The analysis device according to claim 3, wherein the analysis unit determines the association based on a relative frequency of an input operation performed on each of the plurality of input areas.

16. The analysis device according to claim 1, wherein the analysis unit compares relative frequency of an input operation on each of the plurality of input areas during a first period in which a first association between each of the plurality of input areas and the processing is used, with relative frequency of an input operation on each of the plurality of input areas during a second period in which a second association between each of the plurality of input areas and the processing is used, thereby determining which of the first association and the second association is preferable.

17. The analysis device according to claim 2, wherein the analysis unit compares relative frequency of an input operation on each of the plurality of input areas during a first period in which a first association between each of the plurality of input areas and the processing is used, with relative frequency of an input operation on each of the plurality of input areas during a second period in which a second association between each of the plurality of input areas and the processing is used, thereby determining which of the first association and the second association is preferable.

18. The analysis device according to claim 3, wherein the analysis unit compares relative frequency of an input operation on each of the plurality of input areas during a first period in which a first association between each of the plurality of input areas and the processing is used, with relative frequency of an input operation on each of the plurality of input areas during a second period in which a second association between each of the plurality of input areas and the processing is used, thereby determining which of the first association and the second association is preferable.

19. The analysis device according to claim 1, wherein the analysis unit uses time information indicative of time of acceptance of the input by any of the plurality of input areas, to determine the association.

20. The analysis device according to claim 1,
wherein the input unit includes at least a near field radio communication unit configured to perform near field radio communication, and
each of the plurality of input areas is an antenna configured to perform near field radio communication.

21. The analysis device according to claim 20, wherein the analysis unit uses client identification information for identifying the client device held over the antenna, to determine the association.

22. The analysis device according to claim 21, wherein the client identification information is information specifying a user of the client device.

23. The analysis device according to claim 1,
wherein the input unit includes at least a touch panel, and
the plurality of input areas are areas configured on the touch panel.

24. A method for controlling an analysis device communicatively connected to an information processing device including an input unit with a plurality of input areas, each of the input areas being associated with processing performed by the information processing device, the method comprising:
an analysis step of analyzing a log of input performed on any of the plurality of the input areas by an operator output from the information processing device and determining a preferred association between each of the plurality of input areas and the processing based on a prescribed rule.

25. A non-transitory computer-readable recording medium configured to store a control program causing a computer to function as the analysis device according to claim 1, wherein the control program is configured to cause a computer to function as the analysis unit.
